(19) United States
(12) Patent Application Publication
(10) Pub. No.: US 2025/0047419 A1
(43) Pub. Date: Feb. 6, 2025

(54) COMMUNICATION METHOD AND COMMUNICATION APPARATUS

(71) Applicant: HUAWEI TECHNOLOGIES CO., LTD., Shenzhen (CN)

(72) Inventors: Ting WANG, Shanghai (CN); Yongxia LYU, Shenzhen (CN); Dongdong WEI, Shenzhen (CN); Jianglei MA, Ottawa (CA); Peiying ZHU, Ottawa (CA)

(73) Assignee: HUAWEI TECHNOLOGIES CO., LTD., Shenzhen (CN)

(21) Appl. No.: 18/926,890

(22) Filed: Oct. 25, 2024

Related U.S. Application Data
(63) Continuation of application No. PCT/CN2023/090227, filed on Apr. 24, 2023.

(30) Foreign Application Priority Data
Apr. 26, 2022 (CN) 202210445196.X

(51) Int. Cl. H04L 1/1812; H04L 1/1867

(52) U.S. Cl. CPC H04L 1/1816; H04L 1/1867

(57) ABSTRACT

A communication method includes: a first apparatus obtains first information, where the first information indicates the first apparatus to perform multi-link hybrid automatic repeat request (HARQ) combination; the first apparatus receives first data from a first link, where the first data is initial transmission data or retransmission data for third data, and the first link is a link between the first apparatus and a second apparatus; the first apparatus receives second data from a second link, where the second data is retransmission data for the third data, and the second link is a link between the first apparatus and a third apparatus; and the first apparatus performs HARQ combination on the first data and the second data based on the first information.

### CROSS-REFERENCE TO RELATED APPLICATIONS

This application is a continuation of International Application No. PCT/CN2023/090227, filed on Apr. 24, 2023, which claims priority to Chinese Patent Application No. 202210445196.X, filed on Apr. 26, 2022. The disclosures of the aforementioned applications are hereby incorporated by reference in their entireties.

### TECHNICAL FIELD

Embodiments of this disclosure relate to the communication field, and more specifically, to a communication method and a communication apparatus.

### BACKGROUND

With continuous evolution of communication systems, a plurality of communication scenarios represented by ultra-reliability and low-latency communications (URLLC) in a fifth generation mobile communication technology (5G) and a sixth generation mobile communication technology (6G) impose higher requirements on a latency and reliability of communication. The URLLC is used as an example. The URLLC is one of important application scenarios of 5G, and is characterized by a low latency and high reliability. The URLLC may specifically include a “telemetry, remote communication, and remote control” scenario for power automation, an internet of vehicles scenario, an industrial manufacturing scenario, and the like. A requirement for a low latency and high reliability in the industrial manufacturing scenario is the strictest challenging.

Therefore, a communication method needs to be designed to meet the foregoing communication requirement for a low latency and high reliability.

### SUMMARY

This disclosure provides a communication method and a communication apparatus, to implement multi-link hybrid automatic repeat request (HARQ) combination, and help reduce a transmission latency and improve transmission reliability, so as to improve communication performance.

According to a first aspect, a communication method is provided. The method may be performed by a first apparatus or may be performed by a module or a unit in the first apparatus. For ease of description, the module or the unit in the first apparatus is collectively referred to as the first apparatus in the following. The first apparatus may be a terminal, or may be a network device.

The method includes: the first apparatus obtains first information, where the first information indicates the first apparatus to perform multi-link HARQ combination; the first apparatus receives first data from a first link, where the first data is initial transmission data or retransmission data for third data, and the first link is a link between the first apparatus and a second apparatus; the first apparatus receives second data from a second link, where the second data is retransmission data for the third data, and the second link is a link between the first apparatus and a third apparatus; and the first apparatus performs HARQ combination on the first data and the second data based on the first information.

In some embodiments, the initial transmission data and the retransmission data may be received sequentially, or may be received simultaneously.

According to the embodiment, multi-link HARQ combination can be implemented. In this way, when a transmission latency is reduced and transmission reliability is improved through dynamical switching between the plurality of links, a communication performance gain (including a latency gain and a reliability gain) brought by the HARQ combination can be retained, to help reduce the transmission latency and improve the transmission reliability.

In addition, the first apparatus performs HARQ combination on received data based on the first information. This helps avoid a problem that HARQ process numbers are insufficient because the HARQ combination is always valid, and helps avoid an increase in the transmission latency and a reduction in the reliability due to waiting for a HARQ process number.

In some embodiments, the first information includes at least one of the following information: higher layer configuration information, where the higher layer configuration information indicates that the multi-link HARQ combination is enabled; physical layer information, where the physical layer information indicates that the multi-link HARQ combination is activated; or timer information, where the timer information used to configure a timer, and the timer is configured to determine a time period for performing the multi-link HARQ combination. A higher layer includes but is not limited to a radio resource control (RRC) layer and a medium access control (MAC) layer.

When the first information is the higher layer configuration information (that is, when the first information is sent by using higher layer signaling), semi-static configuration for enabling or disabling the multi-link HARQ combination can be implemented, and a HARQ process number can be released in time. This helps avoid extension of transmission time caused by insufficient HARQ process numbers, and helps avoid an increase in a transmission latency and a reduction in reliability due to waiting for the HARQ process number. In addition, a resource of physical layer signaling is usually more strained than that of the higher layer signaling resource. Sending the first information by using the higher layer signaling can reduce overheads of the physical layer signaling. This helps improve communication performance. It should be noted that “enable” herein may also be replaced with “activate”, “start”, or the like.

When the first information is the physical layer information (that is, when the first information is sent by using physical layer signaling), dynamic configuration for activating or deactivating the multi-link HARQ combination can be implemented, and a HARQ process number can be released in time. This helps avoid extension of transmission time caused by insufficient HARQ process numbers, so that decoding performance and HARQ combination efficiency are improved. In addition, compared with a manner in which configuration for the multi-link HARQ combination is performed by using the higher layer configuration information, related configuration for the multi-link HARQ combination can be more flexibly performed in a more timely manner by using the physical layer information. It should be noted that “activate” herein may also be replaced with “enable”, “start”, or the like.

When the first information is the timer information, a HARQ process number can be released in time. This helps avoid extension of transmission time caused by insufficient HARQ process numbers. In addition, whether to perform the multi-link HARQ combination is determined based on effective time of the timer, so that signaling overheads can be reduced.

In some embodiments, the higher layer configuration information is used to enable the multi-link HARQ combination at a granularity of at least one of the following: a terminal, a carrier, a bandwidth part (BWP), a HARQ process, and a HARQ process group.

According to the embodiments, service requirements of different terminals, different carriers, different HARQ processes, different HARQ processes groups), or different BWPs can be met.

In some embodiments, the physical layer information is used to enable the multi-link HARQ combination at a granularity of at least one of the following: a terminal, a carrier, a BWP, a HARQ process, and a HARQ process group.

In some embodiments, the physical layer information is carried in unicast physical layer signaling or multicast physical layer signaling.

In some embodiments, the timer information is used to configure the timer at a granularity of at least one of the following: a terminal, a carrier, a BWP, a HARQ process, and a HARQ process group.

According to the embodiments, service requirements of different terminals, different carriers, different HARQ processes, different HARQ processes groups, or different BWPs can be met.

In some embodiments, the timer information is used to configure duration of the timer based on at least one of the following information: absolute time, a subcarrier spacing, a quantity of symbols, a quantity of slots, or a quantity of subframes.

In some embodiments, a start moment of the timer is a start moment or an end moment of scheduling information, a start moment or an end moment of initial transmission data for the third data, or a start moment or an end moment of a resource that is indicated in the scheduling information and that is used to send feedback information, the scheduling information is used to schedule the first apparatus to receive the initial transmission data for the third data, and the feedback information indicates whether the third data is successfully decoded.

In some embodiments, the method further includes: The first apparatus sends the feedback information, where the feedback information indicates whether the third data is successfully decoded.

In some embodiments, the first link and the second link use joint numbering of HARQ process numbers, and a HARQ process number of the first data is the same as a HARQ process number of the second data.

That the first link and the second link use joint numbering of the HARQ process numbers may be understood as that the first link and the second link use one set of HARQ process numbers. For example, the first link and the second link jointly use 16 HARQ process numbers whose numbers are 0 to 15. In this way, for initial transmission or retransmission of same data, same HARQ process numbers are used on the first link and the second link.

In addition, before receiving the first data, the first apparatus may receive scheduling information used to schedule the first data, where the scheduling information includes a HARQ process number, and the HARQ process number is a HARQ process number of the first data or a HARQ process number corresponding to the first data. Similarly, before receiving the second data, the first apparatus may receive scheduling information used to schedule the second data, where the scheduling information includes a HARQ process number, and the HARQ process number is a HARQ process number of the second data or a HARQ process number corresponding to the second data.

In some embodiments, the method further includes: The first apparatus obtains third information, where the third information indicates a link using joint numbering, and/or the third information indicates whether joint numbering is enabled. In other words, whether the joint numbering is used and/or the link using joint numbering may be configured by the network device.

According to the embodiments, whether the joint numbering is used and/or the link using joint numbering can be flexibly configured.

In some embodiments, whether joint numbering is used and/or a link using joint numbering may be predefined or preconfigured. This helps reduce signaling overheads.

In some embodiments, the first link and the second link use independent numbering of HARQ process numbers, and a HARQ process number of the first data is associated with a HARQ process number of the second data.

That the first link and the second link use independent numbering of the HARQ process numbers may be understood as that the first link and the second link each correspond to one set of HARQ process numbers. For example, the first link uses 16 HARQ process numbers whose numbers are 0 to 15, and the second link uses 32 HARQ process numbers whose numbers are 0 to 31. In this way, for initial transmission or retransmission of same data, HARQ process numbers used on the first link and the second link may be the same or may be different. Therefore, transmission of the same data on the two links needs to be associated.

In addition, before receiving the first data, the first apparatus may receive scheduling information used to schedule the first data, where the scheduling information includes a HARQ process number, and the HARQ process number is a HARQ process number of the first data or a HARQ process number corresponding to the first data. Similarly, before receiving the second data, the first apparatus may receive scheduling information used to schedule the second data, where the scheduling information includes a HARQ process number, and the HARQ process number is a HARQ process number of the second data or a HARQ process number corresponding to the second data.

In some embodiments, the method further includes: The first apparatus obtains fourth information, where the fourth information indicates HARQ process numbers having an association relationship. In other words, the HARQ process numbers having the association relationship may be configured by the network device.

According to the embodiments, the HARQ process numbers having the association relationship can be flexibly configured.

In some embodiments, HARQ process numbers having an association relationship may be predefined or preconfigured. This helps reduce signaling overheads.

In some embodiments, the method further includes: The first apparatus reports second information, where the second information indicates a HARQ combination capability of the first apparatus; and the HARQ combination capability includes at least one of the following: whether the multi-link HARQ combination of a single carrier is supported, whether the multi-link HARQ combination of a plurality of carriers is supported, whether the multi-link HARQ combination of a same subcarrier spacing is supported, whether the multi-link HARQ combination of different subcarrier spacings is supported, whether enabling of the multi-link HARQ combination of semi-static configuration is supported, whether activation of the multi-link HARQ combination of dynamic configuration is supported, whether enabling of the timer-based multi-link HARQ combination is supported, or duration for which data can be buffered.

According to the embodiments, an apparatus (for example, the third apparatus) receiving the second information performs scheduling and configuration based on the HARQ combination capability of the first apparatus. For example, when the first apparatus supports the multi-link HARQ combination of the single carrier, the apparatus receiving the second information may schedule the first data and the second data to be transmitted on a same carrier, and determine, for the first apparatus based on a carrier for which the first apparatus reports supporting the multi-link HARQ combination of the single carrier, the first information to be sent to the first apparatus. A carrier used by a link for which the first information indicates that the multi-link HARQ combination is enabled is the carrier for which the first apparatus reports supporting the multi-link HARQ combination of the single carrier. For another example, when the first apparatus supports the multi-link HARQ combination of the plurality of carriers, the apparatus receiving the second information may schedule the first data and the second data to be transmitted on a same carrier or different carriers, and may determine, for the first apparatus based on a carrier for which the first apparatus reports supporting the multi-link HARQ combination of the plurality of carriers, the first information to be sent to the first apparatus. A carrier used by a link for which the first information indicates that the multi-link HARQ combination is enabled is the carrier for which the first apparatus reports supporting the multi-link HARQ combination of the plurality of carriers. For another example, when the first apparatus supports enabling of the multi-link HARQ combination of the semi-static configuration, the apparatus receiving the second information may send the first information to the first apparatus by using the higher layer signaling. For another example, when the first apparatus supports enabling of the multi-link HARQ combination of the dynamic configuration, the apparatus receiving the second information may send the first information to the first apparatus by using the physical layer signaling. For another example, the apparatus receiving the second information schedules data retransmission within the duration for which data can be buffered and that is reported by the first apparatus. For another example, the apparatus receiving the second information determines, based on the duration for which data can be buffered and that is reported by the first apparatus, a time period for performing the multi-link HARQ combination, and configures the timer for the first apparatus by using the first information. This facilitates data transmission.

According to a second aspect, a communication method is provided. The method may be performed by a third apparatus or may be performed by a module or a unit in the third apparatus. For ease of description, the module or the unit in the third apparatus is collectively referred to as the third apparatus in the following. The third apparatus may be a terminal, or may be a network device.

The method includes: a third apparatus determines first information, where the first information indicates a first apparatus to perform multi-link HARQ combination; and the third apparatus sends the first information to the first apparatus.

According to the embodiment, the third apparatus indicates the first apparatus to perform HARQ combination, so that the first apparatus can implement multi-link HARQ combination. In this way, when a transmission latency is reduced and transmission reliability is improved through dynamical switching between the plurality of links, a communication performance gain (including a latency gain and a reliability gain) brought by the HARQ combination can be retained, to help reduce the transmission latency and improve the transmission reliability.

In addition, the first apparatus performs HARQ combination on received data based on the first information. This helps avoid a problem that HARQ process numbers are insufficient because the HARQ combination is always valid, and helps avoid an increase in the transmission latency and a reduction in the reliability due to waiting for a HARQ process number.

In some embodiments, the first information includes at least one of the following information: higher layer configuration information, where the higher layer configuration information indicates that the multi-link HARQ combination is enabled; physical layer information, where the physical layer information indicates that the multi-link HARQ combination is activated; or timer information, where the timer information is used to configure a timer, and the timer is configured to determine a time period for performing the multi-link HARQ combination. A higher layer includes but is not limited to an RRC layer and a MAC layer.

When the first information is the higher layer configuration information (that is, when the first information is sent by using higher layer signaling), semi-static configuration for enabling or disabling the multi-link HARQ combination can be implemented, and a HARQ process number can be released in time. This helps avoid extension of transmission time caused by insufficient HARQ process numbers, and helps avoid an increase in a transmission latency and a reduction in reliability due to waiting for the HARQ process number. In addition, a resource of physical layer signaling is usually more strained than that of the higher layer signaling resource. Sending the first information by using the higher layer signaling can reduce overheads of the physical layer signaling. This helps improve communication performance.

When the first information is the physical layer information (that is, when the first information is sent by using physical layer signaling), dynamic configuration for enabling or disabling the multi-link HARQ combination can be implemented, and a HARQ process number can be released in time. This helps avoid extension of transmission time caused by insufficient HARQ process numbers, so that decoding performance and HARQ combination efficiency are improved. In addition, compared with a manner in which configuration for the multi-link HARQ combination is performed by using the higher layer configuration information, related configuration for the multi-link HARQ combination can be more flexibly performed in a more timely manner by using the physical layer information.

When the first information is the timer information, a HARQ process number can be released in time. This helps avoid extension of transmission time caused by insufficient HARQ process numbers. In addition, whether to perform the multi-link HARQ combination is determined based on effective time of the timer, so that signaling overheads can be reduced.

In some embodiments, the higher layer configuration information is used to enable the multi-link HARQ combination at a granularity of at least one of the following: a terminal, a carrier, a BWP, a HARQ process, and a HARQ process group.

According to the embodiments, service requirements of different terminals, different carriers, different HARQ processes, different HARQ processes groups, or different BWPs can be met.

In some embodiments, the physical layer information is used to enable the multi-link HARQ combination at a granularity of at least one of the following: a terminal, a carrier, a BWP, a HARQ process, and a HARQ process group.

In some embodiments, the physical layer information is carried in unicast physical layer signaling or multicast physical layer signaling.

In some embodiments, the timer information is used to configure the timer at a granularity of at least one of the following: a terminal, a carrier, a BWP, a HARQ process, and a HARQ process group.

According to the embodiments, service requirements of different terminals, different carriers, different HARQ processes, different HARQ processes groups, or different BWPs can be met.

In some embodiments, the timer information is used to configure duration of the timer based on at least one of the following information: absolute time, a subcarrier spacing, a quantity of symbols, a quantity of slots, or a quantity of subframes.

In some embodiments, a start moment of the timer is a start moment or an end moment of scheduling information, a start moment or an end moment of initial transmission data for third data, or a start moment or an end moment of a resource that is indicated in the scheduling information and that is used to send feedback information, the scheduling information is used to schedule the first apparatus to receive the initial transmission data for the third data, and the feedback information indicates whether the third data is successfully decoded.

In some embodiments, the method further includes: The third apparatus receives the feedback information from the first apparatus, where the feedback information indicates whether the third data is successfully decoded.

In some embodiments, the method further includes: The third apparatus sends third information to the first apparatus, where the third information indicates a link using joint numbering, and/or the third information indicates whether joint numbering is enabled.

According to the embodiments, whether the joint numbering is used and/or the link using joint numbering can be flexibly configured.

In some embodiments, the method further includes: The third apparatus sends fourth information to the first apparatus, where the fourth information indicates HARQ process numbers having an association relationship.

According to the embodiments, the HARQ process numbers having the association relationship can be flexibly configured.

In some embodiments, the method further includes: The third apparatus receives second information reported by the first apparatus, where the second information indicates a HARQ combination capability of the first apparatus; and the HARQ combination capability includes at least one of the following: whether the multi-link HARQ combination of a single carrier is supported, whether the multi-link HARQ combination of a plurality of carriers is supported, whether the multi-link HARQ combination of a same subcarrier spacing is supported, whether the multi-link HARQ combination of different subcarrier spacings is supported, whether enabling of the multi-link HARQ combination of semi-static configuration is supported, whether activation of the multi-link HARQ combination of dynamic configuration is supported, whether enabling of the timer-based multi-link HARQ combination is supported, or duration for which data can be buffered.

In some embodiments, that the third apparatus determines the first information includes: The third apparatus determines the first information based on the second information.

For example, the first apparatus may report, per carrier, whether the multi-link HARQ combination of the single carrier is supported, and the third apparatus may determine, for the first apparatus based on a carrier for which the first apparatus reports supporting the multi-link HARQ combination of the single carrier, the first information to be sent to the first apparatus. A carrier used by a link for which the first information indicates that the multi-link HARQ combination is enabled is the carrier for which the first apparatus reports supporting the multi-link HARQ combination of the single carrier.

For example, the first apparatus may report, per carrier or per carrier group, whether the multi-link HARQ combination of the plurality of carriers is supported, and the third apparatus may determine, for the first apparatus based on a carrier for which the first apparatus reports supporting the multi-link HARQ combination of the plurality of carriers, the first information to be sent to the first apparatus. A carrier used by a link for which the first information indicates that the multi-link HARQ combination is enabled is the carrier for which the first apparatus reports supporting the multi-link HARQ combination of the plurality of carriers.

For another example, when the first apparatus supports enabling of the multi-link HARQ combination of the semi-static configuration, the third apparatus may send the first information to the first apparatus by using the higher layer signaling. In other words, the third apparatus may indicate, by using the higher layer signaling, whether the multi-link HARQ combination is enabled.

For another example, when the first apparatus supports enabling of the multi-link HARQ combination of the dynamic configuration, the third apparatus may send the first information to the first apparatus by using the physical layer signaling. In other words, the third apparatus may indicate, by using the physical layer signaling, whether the multi-link HARQ combination is activated.

For another example, when the first apparatus supports enabling of the timer-based multi-link HARQ combination, the third apparatus may configure the timer for the first apparatus by using the first information. The timer is configured to determine the time period for performing the multi-link HARQ combination.

For another example, if the first apparatus reports the duration for which data can be buffered to the third apparatus, the third apparatus determines, based on the duration for which data can be buffered and that is reported by the first apparatus, the time period for performing the multi-link HARQ combination, and configures the timer for the first apparatus by using the first information.

According to the embodiments, an apparatus (for example, the third apparatus) receiving the second information performs scheduling and configuration based on the HARQ combination capability of the first apparatus. This facilitates data transmission.

In some embodiments, the method further includes: The third apparatus sends second data to the first apparatus, where the second data is retransmission data for third data.

In some embodiments, the method further includes: The third apparatus sends scheduling information to a second apparatus, where the scheduling information is used to schedule the second apparatus to send first data to the first apparatus, and the first data is initial transmission data or retransmission data for the third data.

According to a third aspect, a communication apparatus is provided. The communication apparatus may be used in the first apparatus in the first aspect. The communication apparatus may be the first apparatus, may be a module or a unit (for example, a chip, a chip system, or a circuit) in the first apparatus, or may be an apparatus that can be used together with the first apparatus. The communication apparatus may include a module or a unit one-to-one corresponding to the method/operation/step/action according to the first aspect. The module or the unit may be a hardware circuit, may be software, or may be implemented by the hardware circuit in combination with the software.

In some embodiments, the communication apparatus includes a transceiver unit and a processing unit.

In some embodiments, the communication apparatus is a first apparatus. When the communication apparatus is the first apparatus, the transceiver unit may be a transceiver, an input/output interface, or a communication interface; and the processing unit may be at least one processor. Optionally, the transceiver is a transceiver circuit. Optionally, the input/output interface is an input/output circuit.

In some embodiments, the communication apparatus is a chip, a chip system, or a circuit used in the first apparatus. When the communication apparatus is the chip, the chip system, or the circuit used in the first apparatus, the transceiver unit may be an input/output interface, an interface circuit, an output circuit, an input circuit, a pin, a related circuit, or the like on the chip, the chip system, or the circuit; and the processing unit may be at least one processor, a processing circuit, a logic circuit, or the like.

According to a fourth aspect, a communication apparatus is provided. The communication apparatus may be used in the third apparatus in the second aspect. The communication apparatus may be the third apparatus, may be a module or a unit (for example, a chip, a chip system, or a circuit) in the third apparatus, or may be an apparatus that can be used together with the third apparatus. The communication apparatus may include a module or a unit one-to-one corresponding to the method/operation/step/action according to the second aspect. The module or the unit may be a hardware circuit, may be software, or may be implemented by the hardware circuit in combination with the software.

In some embodiments, the communication apparatus includes: a transceiver unit and a processing unit.

In some embodiments, the communication apparatus is a third apparatus. When the communication apparatus is the third apparatus, the transceiver unit may be a transceiver, an input/output interface, or a communication interface; and the processing unit may be at least one processor. Optionally, the transceiver is a transceiver circuit. Optionally, the input/output interface is an input/output circuit.

In some embodiments, the communication apparatus is a chip, a chip system, or a circuit used in the third apparatus. When the communication apparatus is the chip, the chip system, or the circuit used in the third apparatus, the transceiver unit may be an input/output interface, an interface circuit, an output circuit, an input circuit, a pin, a related circuit, or the like on the chip, the chip system, or the circuit; and the processing unit may be at least one processor, a processing circuit, a logic circuit, or the like.

According to a fifth aspect, a communication apparatus is provided. The apparatus includes: a memory, configured to store a program; and at least one processor, configured to execute a computer program or instructions stored in the memory, to perform the method according to any one of the foregoing aspects or the implementations of the foregoing aspects.

In some embodiments, the communication apparatus is the first apparatus according to the first aspect or the third apparatus according to the second aspect.

In some embodiments, the communication apparatus is a chip, a chip system, or a circuit used in the first apparatus according to the first aspect or the third apparatus according to the second aspect.

According to a sixth aspect, a communication apparatus is provided. The apparatus includes: at least one processor and a communication interface. The at least one processor is configured to obtain, through the communication interface, a computer program or instructions stored in a memory, to perform the method according to any one of the foregoing aspects or the implementations of the foregoing aspects. The communication interface may be implemented by hardware or software.

In some embodiments, the apparatus further includes the memory.

According to a seventh aspect, a processor is provided, configured to perform the method according to the foregoing aspects.

Operations such as sending and obtaining/receiving related to the processor may be understood as operations such as output and receiving or input of the processor, or operations such as sending and receiving performed by a radio frequency circuit and an antenna, unless otherwise specified, or provided that the operations do not contradict actual functions or internal logic of the operations in related descriptions. This is not limited in this disclosure.

According to an eighth aspect, a computer-readable storage medium is provided. The computer-readable storage medium stores program code to be executed by a device, and the program code is used to perform the method according to any one of the foregoing aspects or the implementations of the foregoing aspects.

According to a ninth aspect, a computer program product including instructions is provided. When the computer program product runs on a computer, the computer is enabled to perform the method according to any one of the foregoing aspects or the implementations of the foregoing aspects.

According to a tenth aspect, a chip is provided. The chip includes a processor and a communication interface. The processor reads, through the communication interface, instructions stored in a memory, to perform the method according to any one of the foregoing aspects or the implementations of the foregoing aspects. The communication interface may be implemented by hardware or software.

Optionally, in an implementation, the chip further includes the memory. The memory stores a computer program or the instructions. The processor is configured to execute the computer program or the instructions stored in the memory. When the computer program or the instructions are executed, the processor is configured to perform the method according to any one of the foregoing aspects or the implementations of the foregoing aspects.

According to an eleventh aspect, a communication system is provided, including the first apparatus according to the first aspect and/or the third apparatus according to the second aspect.

### BRIEF DESCRIPTION OF DRAWINGS

FIG. 1 is a diagram of a network architecture of a communication system in an industrial manufacturing scenario;

FIG. 2 is a diagram of a scenario in which a plurality of links are uniformly scheduled;

FIG. 3 is a diagram of a network architecture of a satellite communication system;

FIG. 4 is a diagram of a network architecture of an inter-satellite communication system;

FIG. 5 is a diagram of a network architecture of a cellular communication system;

FIG. 6 is a diagram of wireless projection;

FIG. 7 is a diagram of a network architecture of an integrated access and backhaul (IAB) communication system;

FIG. 8 is an interaction diagram of a communication method according to this disclosure;

FIG. 9 is a diagram of multi-link HARQ combination of a single carrier;

FIG. 10 is a diagram of multi-link HARQ combination of a plurality of carriers;

FIG. 11 is a diagram of dedicated multicast physical layer signaling according to this disclosure;

FIG. 12 is a diagram of multicast physical layer signaling according to this disclosure;

FIG. 13 is another diagram of multicast physical layer signaling according to this disclosure;

FIG. 14 is a diagram of a start moment of a timer;

FIG. 15 is another diagram of a start moment of a timer;

FIG. 16 is an example of a communication method according to this disclosure;

FIG. 17 is a diagram of a structure of an apparatus according to this disclosure; and

FIG. 18 is another diagram of a structure of an apparatus according to this disclosure.

### DESCRIPTION OF EMBODIMENTS

The following describes technical solutions of this disclosure with reference to accompanying drawings.

For ease of understanding embodiments of this disclosure, before embodiments of this disclosure are described, the following descriptions are first provided.

In this disclosure, “indicating” or “indicate” may include a direct indication and an indirect indication, or “indicating” or “indicate” may be an explicit indication and/or an implicit indication. For example, when a piece of indication information is described as indicating information I, the indication information may directly indicate I or indirectly indicate I, but it does not necessarily indicate that the indication information carries I. For another example, the implicit indication may be based on a location and/or a resource used for transmission; and the explicit indication may be based on one or more parameters, and/or one or more indexes, and/or one or more bit patterns represented by the explicit indication.

Definitions of many features listed in this disclosure are merely used to explain functions of the features by using examples.

In the following embodiments, first, second, third, fourth, and various numbers are merely used for differentiation for ease of description, but are not used to limit the scope of embodiments of this disclosure. For example, the numbers are used for differentiation between different fields and different information.

“Predefined” may be implemented by storing corresponding code or a table in a device (for example, the device includes a terminal and a network device) in advance, or may be implemented in another manner that may indicate related information. A specific embodiment of “predefined” is not limited in this disclosure. “Storage” may be storage in one or more memories. A type of the memory may be a storage medium in any form.

A “protocol” in embodiments of this disclosure may be a standard protocol in the communication field, for example, may include a long term evolution (long term evolution, LTE) protocol, a new radio (new radio, NR) protocol, and a related protocol applied to a future communication system.

Each aspect, embodiment, or feature is presented in this disclosure with reference to a system including a plurality of devices, components, modules, and the like. It should be appreciated and understood that, each system may include another device, component, and module, and the like, and/or may not include all devices, components, and modules, and the like discussed with reference to the accompanying drawings. In addition, a combination of these solutions may be used.

In embodiments of this disclosure, the word “example” or “for example” is used to represent giving an example, an illustration, or a description. Any embodiment or design scheme described as an “example” in this disclosure should not be explained as being more preferred or having more advantages than another embodiment or design scheme. Exactly, the term “example” is used to present a concept in a specific manner.

The terms “include”, “have”, and their variants all mean “include but are not limited to”, unless otherwise specifically emphasized in another manner.

“At least one” means one or more, and “a plurality of” means two or more. The term “and/or” describes an association relationship between associated objects and indicates that three relationships may exist. For example, A and/or B may indicate the following three cases: Only A exists, both A and B exist, and only B exists. A and B each may be singular or plural. The character “/” generally indicates an “or” relationship between the associated objects. “At least one of the following items (pieces)” or a similar expression thereof refers to any combination of these items, including any combination of singular items (pieces) or plural items (pieces). For example, at least one item (piece) of a, b, and c may indicate a, b, c, a and b, a and c, b and c, or a, b, and c. Each of a, b, and c may be in a singular form or a plural form.

The technical solutions provided in this disclosure may be applied to various communication systems, for example, a fifth generation (5G) communication system such as an NR system, an LTE system, an LTE frequency division duplex (FDD) system, and an LTE time division duplex (TDD) system. The technical solutions provided in this disclosure may be further applied to a communication system evolved after 5G, for example, a sixth generation mobile communication system.

The technical solutions provided in this disclosure may be further applied to a non-terrestrial network (NTN) communication system such as a satellite communication system. The NTN communication system may be integrated with a wireless communication system. The technical solutions in embodiments of this disclosure may be further applied to an inter-satellite communication system, a wireless projection system, a virtual reality (VR) communication system, an IAB system, a wireless fidelity (Wi-Fi) communication system, an optical communication system, and the like. The technical solutions provided in this disclosure may be further applied to a D2D communication system, a vehicle-to-everything (V2X) communication system, a machine-to-machine (M2M) communication system, a machine type communication (MTC) system, an internet of things (IoT) communication system, an integrated sensing and communication system, or another communication system. This disclosure does not specifically limit the communication system to which the technical solutions are applied and a network architecture of the communication system.

A network device in this disclosure may be a device configured to communicate with a terminal, or may be a device for enabling the terminal to access a wireless network. The network device may be a node in a radio access network. The network device may be a base station, an evolved NodeB (eNodeB), a transmission reception point (TRP), a home base station (for example, a home evolved NodeB or a home NodeB, HNB), a Wi-Fi access point (AP), a mobile switching center, a next generation NodeB (gNB) in a 5G mobile communication system, a next generation NodeB in a sixth generation (6G) mobile communication system, a base station in a future mobile communication system, or the like. The network device may alternatively be a module or a unit that implements some functions of the base station, for example, a central unit (CU), a distributed unit (DU), an RRU, or a baseband unit (BBU). The network device may alternatively be a device that functions as a base station in the D2D communication system, the V2X communication system, the M2M communication system, or the IoT communication system. The network device may alternatively be a network device in an NTN, that is, the network device may be deployed on a high-altitude platform or a satellite. The network device may be a macro base station, a micro base station, an indoor base station, a relay node, a donor node, or the like. Certainly, the network device may alternatively be a node in a core network. A specific technology, a device form, and a name that are used by the network device are not limited in embodiments of this disclosure.

The terminal in this disclosure is a device having a wireless transceiver function, and may also be referred to as user equipment (UE), a subscriber, an access terminal, a subscriber unit, a subscriber station, a mobile station, a remote station, a remote terminal, a mobile device, a subscriber terminal, a terminal device, a wireless communication device, a user agent, a user apparatus, or the like. The terminal may be a mobile phone, a tablet computer (e.g. a Pad), customer-premises equipment (CPE), a smart point of sale (POS) machine, a communication device carried on a high-altitude aircraft, a wearable device, an uncrewed aerial vehicle, a robot, a computer having a wireless transceiver function, a virtual reality (VR) terminal, an augmented reality (AR) terminal, a terminal in satellite communication, a terminal in an IAB system, a terminal in a Wi-Fi communication system, a terminal in industrial control, a terminal in self-driving, a terminal in telemedicine, a terminal in a smart grid, a terminal in transportation safety, a terminal in a smart city, a terminal in a smart home, a sensor, a device in integrated sensing and communication, or the like. A specific technology, a device form, and a name that are used by the terminal are not limited in embodiments of this disclosure.

It should be noted that roles of the network device and the terminal may be relative. For example, a network device #1 may be configured as a mobile base station. For terminals that access a network via the network device #1, the network device #1 is a base station. However, for a network device #2 that communicates with the network device #1 based on a radio air interface protocol, the network device #1 is a terminal. Certainly, the network device #1 and the network device #2 may also communicate with each other based on an interface protocol between base stations. In this case, the network device #1 is also a base station for the network device #2.

In this disclosure, both the network device and the terminal may be collectively referred to as a communication apparatus. For example, the base station may be referred to as a communication apparatus having a base station function, and the terminal may be referred to as a communication apparatus having a terminal function. The network device and the terminal in this disclosure may be deployed on land, including an indoor or outdoor terminal, a handheld terminal, a wearable terminal, or a vehicle-mounted terminal; or may be deployed on a water surface (for example, on a ship); or may be deployed in the air (for example, on an airplane, a balloon, or a satellite). Application scenarios of the network device and the terminal are not limited in this disclosure.

In this disclosure, communication between a network device and a terminal, between network devices, and between terminals may be performed by using a licensed spectrum, may be performed by using an unlicensed spectrum, or may be performed by using both a licensed spectrum and an unlicensed spectrum. The technical solutions of this disclosure are applicable to a low-frequency scenario (for example, sub 6G), a high-frequency scenario (for example, above 6G), terahertz (THz) frequency band, optical communication, and the like. For example, the network device and the terminal may communicate with each other by using a spectrum below 6 gigahertz (GHz), may communicate with each other by using a spectrum above 6 GHz, or may communicate with each other by using both the spectrum less than 6 GHz and the spectrum greater than 6 GHz. A spectrum resource used for communication is not limited in embodiments of this disclosure.

In this disclosure, a function of the network device may alternatively be performed by a module (for example, a chip) in the network device, or may be performed by a control subsystem including the function of the network device. The control subsystem including the function of the network device herein may be a control center in the foregoing terminal application scenarios such as the smart grid, the industrial control, the intelligent transportation, and the smart city. A function of the terminal may alternatively be performed by a module (for example, a chip or a modem) in the terminal, or may be performed by an apparatus including the function of the terminal.

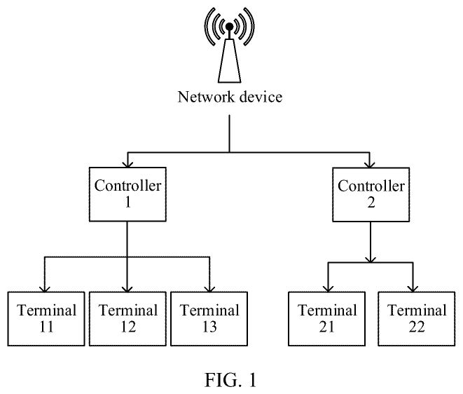

For example, FIG. 1 to FIG. 7 show several scenarios to which the technical solutions of this disclosure may be applied.

FIG. 1 is a diagram of a network architecture of a communication system in an industrial manufacturing scenario.

In the industrial manufacturing scenario, an industrial device may access an enterprise cloud or an industrial field control system via a wireless communication system (for example, a 5G communication system), and the industrial device may collect environmental data and production data of an industrial field and feed back the environmental data and the production data to the enterprise cloud or the industrial field control system, so that the enterprise cloud or the industrial field control system analyzes a production status in real time.

As shown in FIG. 1, in an actual industrial manufacturing scenario, a two-layer network structure is generally used, and includes a network device, terminals at a middle layer (for example, a controller 1 and a controller 2), and terminals at a bottom layer (for example, a terminal 11, a terminal 12, a terminal 13, a terminal 21, and a terminal 22). The terminals at the middle layer may be controllers, and the terminals at the bottom layer may be various production devices. Different devices need to communicate with each other through different links. For example, a terminal at the middle layer may communicate with a terminal at the bottom layer through a sidelink, and the terminal at the middle layer and the terminal at the bottom layer may communicate with the network device through a Uu interface.

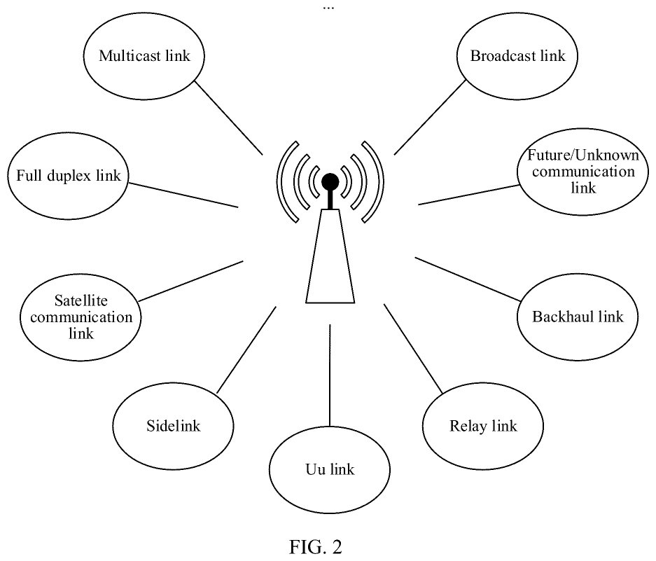

FIG. 2 is a diagram of a scenario in which a plurality of links are uniformly scheduled.

In the scenario in which the plurality of links are uniformly scheduled, a device responsible for uniform scheduling uniformly performs dynamic resource scheduling on broadcast link, a backhaul link, a relay link, a Uu link, a sidelink, satellite communication link, full duplex link, multicast link, and the like. In this disclosure, the device responsible for uniform scheduling may schedule one device to send data to another device. For example, a network device responsible for uniform scheduling may schedule a device A to send data to a device B, and schedule the device A to receive data from the device B, where the device A and the device B may be any devices in a communication system.

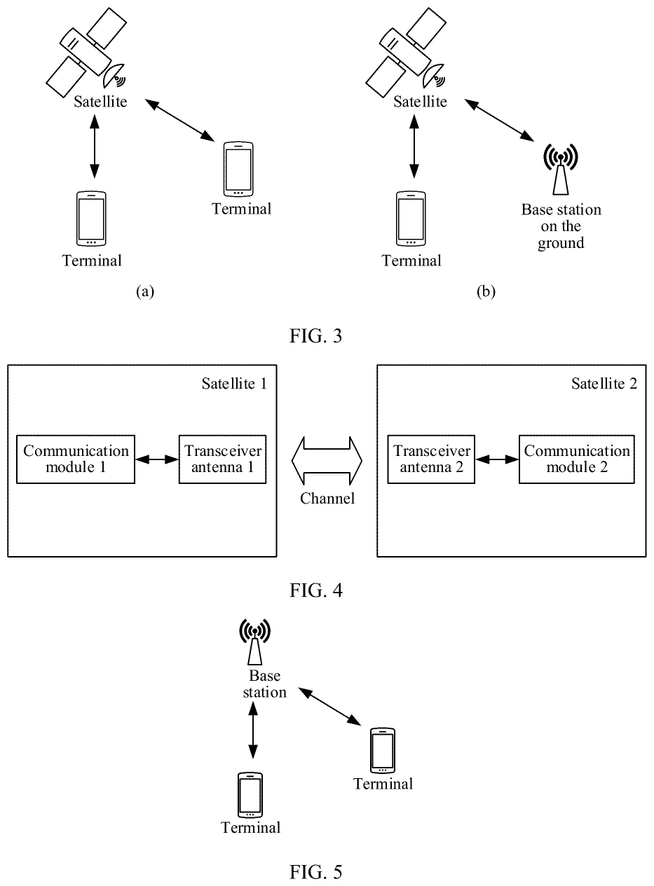

FIG. 3 is a diagram of a network architecture of a satellite communication system.

As shown a figure (a) in FIG. 3, the network architecture may include a satellite and a terminal. The satellite provides a communication service for the terminal. The satellite may send downlink data to the terminal, where the data may be encoded through channel encoding, and after constellation modulation is performed on data obtained through the channel encoding, the data is sent to the terminal. The terminal may also send uplink data to the satellite, where the uplink data may also be encoded through channel encoding, and after constellation modulation is performed on encoded data, the data is sent to the satellite. As shown a figure (b) in FIG. 3, the network architecture may further include a base station on the ground. The satellite may further communicate with the base station on the ground.

The satellite may be an uncrewed aerial vehicle, a hot air balloon, a low earth orbit satellite, a medium earth orbit satellite, a high earth orbit satellite, or the like. The satellite may alternatively be a non-terrestrial base station, a non-terrestrial device, or the like. The satellite may be used as both a network device and a terminal. The satellite may not have a function of the base station, or may have all or some functions of the base station. This is not limited in this disclosure.

FIG. 4 is a diagram of a network architecture of an inter-satellite communication system.

The inter-satellite communication system may also be referred to as an inter-satellite link communication system or the like. In the inter-satellite communication system, satellites may communicate with each other. For example, as shown in FIG. 4, a satellite 1 may include a communication module 1 and a transceiver antenna 1, and a satellite 2 may include a communication module 2 and a transceiver antenna 2. The communication module 1 of the satellite 1 may send data to the satellite 2 via the transceiver antenna 1. Correspondingly, the transceiver antenna 2 of the satellite 2 may receive the data from the transceiver antenna 1, and transmit the data to the communication module 2 of the satellite 2. The data may be encoded through channel encoding. On the contrary, the communication module 2 of the satellite 2 may send data to the satellite 1 via the transceiver antenna 2. Correspondingly, the transceiver antenna 1 of the satellite 1 may receive the data from the transceiver antenna 2, and transmit the data to the communication module 1 of the satellite 1. The data may be encoded through channel encoding.

FIG. 5 is a diagram of a network architecture of a cellular communication system.

As shown in FIG. 5, the cellular communication system usually includes cells, each cell includes one base station, and the base station may provide a communication service for one or more terminals. Specifically, the base station may send downlink data to a terminal, where the data may be encoded through channel encoding. The terminal may also send uplink data to the base station, where the uplink data may be encoded through channel encoding. FIG. 6 is a diagram of wireless projection.

Wireless projection is also referred to as wireless screen sharing, a flying screen, screen sharing, or the like. Specifically, a picture of a device A (for example, a mobile phone, a tablet computer, a notebook computer, or a computer) is displayed on a screen of another device B (for example, a tablet computer, a notebook computer, a computer, a television, an all-in-one machine, or a projector) in “real time”. Output content may include various types of media information and a real-time operation picture.

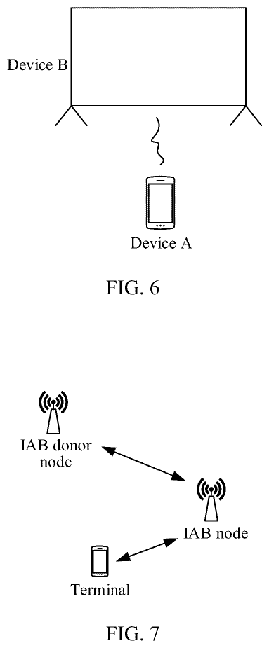

FIG. 7 is a diagram of a network architecture of an IAB communication system.

As shown in FIG. 7, the IAB communication system includes an IAB donor node (also referred to as an IAB parent node) (IAB donor), an IAB node, and a terminal. The IAB donor node may access a core network (not shown in FIG. 5) through an NG interface, and the IAB node may access the IAB donor node through a Uu interface, to form a link for signal transmission. The terminal may access a network by accessing only the IAB node. Signaling exchange between the terminal and a network side needs to be performed through the IAB node and the IAB donor node in sequence. In a multi-hop data backhaul scenario, signaling exchange between the terminal and the network side needs to be performed through a plurality of IAB nodes.

A link between the IAB nodes and a link between the IAB node and the IAB donor node may be referred to as backhaul links. A link between the IAB node and the terminal may be referred to as an access link.

It should be noted that the scenarios shown in FIG. 1 to FIG. 7 are merely examples of the scenarios to which the technical solutions of this disclosure may be applied. The technical solutions of this disclosure may be further applied to other scenarios. For example, the technical solutions of this disclosure are also applicable to AR/VR games, data encoding and decoding in a mobile phone application (APP), and inter-device and intra-device interaction and communication.

For ease of understanding, the following briefly describes nouns, terms, or technologies in this disclosure.

### 1. Hybrid Automatic Repeat Request (HARQ) Technology

In a wireless communication system, a transmitter and a receiver usually use the HARQ technology to ensure correctness of data transmission. The HARQ technology is to combine forward error correction (FEC) and an automatic repeat request (ARQ).

Specifically, a transmitter device sends an encoded transport block (TB) (which may be referred to as initial transmission data or new transmission data) to a receiver device. The transport block includes information bits and some redundant bits. If the receiver device can correctly decode the received transport block, the receiver device feeds back an acknowledgment (ACK) to the transmitter device. After receiving the ACK, the transmitter device confirms that the receiver device has successfully received the corresponding information bits, and considers that the transport block has been successfully transmitted. If the receiver device cannot correctly decode the received transport block, the receiver device feeds back a negative acknowledgment (NACK) to the transmitter device. After receiving the NACK, the transmitter device further transmits some information bits and/or redundant bits (which may be referred to as retransmission data) to the receiver device. After receiving the retransmission data, the receiver device combines the retransmission data with previously received data and performs decoding. If the received data still cannot be correctly decoded based on the retransmission data, retransmission may be performed again. As a quantity of times of retransmission increases, information bits and/or redundant bits are continuously accumulated, and a channel encoding rate is continuously reduced, so that a decoding effect can be continuously improved.

### 2. HARQ Process

HARQ process: A HARQ uses a stop-and-wait protocol to send data. In the stop-and-wait protocol, each time after sending a data block, the transmitter device stops to wait for an ACK or a NACK. Because the transmitter device stops to wait for an ACK or a NACK after each time of transmission, a throughout is very low. Therefore, a plurality of processes may be used. To be specific, when an ACK or a NACK for one HARQ process is waited for, the transmitter device may continue to send data through another HARQ process.

Generally, within a transmission time interval (TTI), one data block is provided in one HARQ process, that is, the data block one-to-one corresponds to the HARQ process. One HARQ process corresponds to one HARQ process number, and the HARQ process number may uniquely identify the HARQ process. The HARQ process number may also be referred to as a HARQ process ID.

A HARQ process group may also be referred to as a HARQ process number group, and includes one or more HARQ process numbers. In this disclosure, HARQ process numbers may be grouped, and a HARQ process group is configured. That the HARQ process group is configured may be understood as that same configuration is performed on HARQ processes in the HARQ process group, or the HARQ processes in the HARQ process group may correspond to same configuration.

### 3. HARQ Combination

Each HARQ process has an independent HARQ buffer in the receiver device. When the receiver device cannot correctly decode a received data block, the receiver device places received data in a HARQ buffer corresponding to the data block, so that the received data and subsequently received retransmission data are combined and decoded.

In some embodiments, the receiver device may determine, based on a HARQ process number in scheduling information used to schedule data, a HARQ process to which received data belongs.

In this disclosure, HARQ combination may be implemented through HARQ chase, HARQ soft combining, HARQ hard combining, symbol-level combination, bit-level combination, or the like.

In this disclosure, HARQ combination, e.g. multi-link HARQ combination, may be performed on data from a plurality of links. It should be noted that, in this disclosure, the multi-link HARQ combination may alternatively be replaced with another description manner, for example, joint receiving of multi-link data, joint decoding of multi-link data, joint coding of multi-link data, combined receiving of multi-link data, combined decoding of multi-link data, or combined coding of multi-link data. For ease of description, a description manner of multi-link HARQ combination is uniformly used below.

### 4. Communication Pair and Link

The communication pair includes a transmitter device and a receiver device. The receiver device may also be referred to as a receive end, a receiving device, or the like, and is a device receiving data. Similarly, the transmitter device may also be referred to as a transmit end, a sending device, or the like, and is a device sending data.

Types of the transmitter device and the receiver device included in the communication pair are not limited in this disclosure. For example, the communication pair may include a base station and a terminal, terminals, a terminal and a relay device, a relay device and a base station, satellites, a satellite and a base station, a satellite and a terminal, or heterogeneous network (HetNet) devices. The transmitter device may include one or more devices, and the receiver device may include one or more devices.

One link corresponds to communication of one communication pair. In correspondence to the communication pair, the link may be a Uu link, a sidelink, a backhaul link, or the like.

The following describes in detail a communication method provided in embodiments of this disclosure with reference to the accompanying drawings.

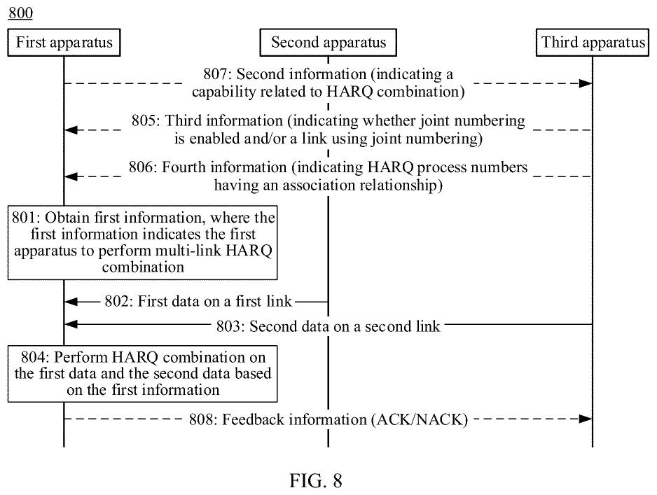

FIG. 8 is an interaction diagram of a communication method 800 according to this disclosure. The method 800 may be performed by a first apparatus, a second apparatus, and a third apparatus, or may be performed by modules or units in the first apparatus, the second apparatus, and the third apparatus. For ease of description, the modules or the units in the first apparatus, the second apparatus, and the third apparatus are referred to as the first apparatus, the second apparatus, and the third apparatus below.

In the method 800, the technical solutions of this disclosure are described by using an example in which the first apparatus is a receiver device and the second apparatus and the third apparatus are transmitter devices. However, actually, the first apparatus may be used as both a receiver device and a transmitter device. When the first apparatus is used as the transmitter device, for a method or a step performed by the first apparatus, refer to the second apparatus or the third apparatus. Similarly, the second apparatus and/or the third apparatus may be used as both transmitter devices/a transmitter device and receiver devices/a receiver device. When the second apparatus and/or the third apparatus is used as the receiver devices/the receiver device, for a method or a step performed by the second apparatus and/or the third apparatus, refer to the first apparatus.

In addition, types of the first apparatus, the second apparatus, and the third apparatus are not specifically limited in this disclosure. For example, the first apparatus, the second apparatus, and the third apparatus may be terminals or network devices.

The method 800 may include at least a part of the following content.

Block 801: The first apparatus obtains first information.

The first information indicates the first apparatus to perform multi-link HARQ combination.

In some embodiments, the first apparatus receives the first information from the third apparatus. Correspondingly, the third apparatus sends the first information to the first apparatus. Optionally, before sending the first information, the third apparatus may determine the first information. It should be noted that a plurality of links on which HARQ combination is performed may include or not include a link between the first apparatus and an apparatus providing the first information for the first apparatus. To clearly describe the technical solutions of this disclosure, an example in which the third apparatus provides the first information for the first apparatus and may also send data to the first apparatus as the transmitter device (which is described below) is used herein for description. In other words, the first apparatus may obtain the first information from the third apparatus, or may obtain the first information from an apparatus other than the second apparatus and the third apparatus. Second information, third information, and fourth information in the following are similar to the first information, and are not explained in the following.

In this disclosure, the plurality of links on which the HARQ combination is performed may be links of a same type, or may be links of different types. For example, the plurality of links on which the HARQ combination is performed are a Uu link #1 and a Uu link #2. For another example, the plurality of links on which the HARQ combination is performed are a Uu link #1 and a sidelink #1. For another example, the plurality of links on which the HARQ combination is performed are a Uu link #1, a sidelink #1, and a backhaul link #1. For another example, the plurality of links on which the HARQ combination is performed are a Uu link #1, a Uu link #2, and a sidelink #1.

In this disclosure, data may be transmitted, by using a same carrier or different carriers, on the plurality of links on which the HARQ combination is performed. This is not limited in this disclosure.

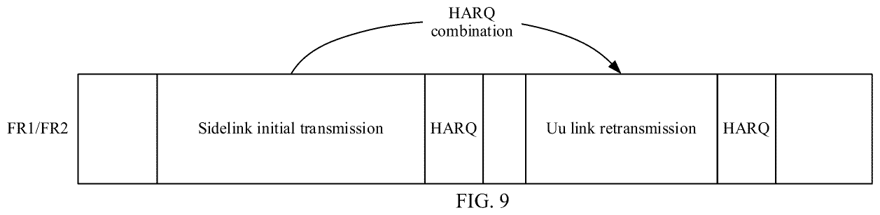

FIG. 9 is a diagram of multi-link HARQ combination of a single carrier. As shown in FIG. 9, the first apparatus operating in a frequency range of FR1 or FR2 performs HARQ combination on initial transmission data on a sidelink and retransmission data on a Uu link. In this case, the initial transmission data and the retransmission data on the plurality of links are transmitted on a same carrier, and the receiver device may perform HARQ combination on the initial transmission data and the retransmission data.

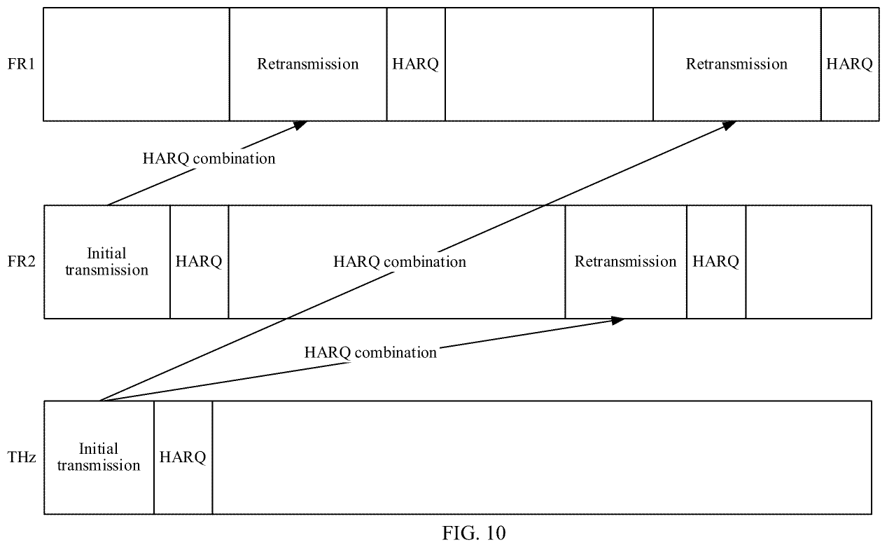

FIG. 10 is a diagram of multi-link HARQ combination of a plurality of carriers. As shown in FIG. 10, the first apparatus supporting frequency ranges of FR1, FR2, and THz frequency band may perform HARQ combination on initial transmission data in FR2 and retransmission data in FR1, perform HARQ combination on initial transmission data in THz frequency band and retransmission data in FR2, or perform HARQ combination on the initial transmission data in THz frequency band and the retransmission data in FR1. In this case, the initial transmission data and the retransmission data on the plurality of links are transmitted on different carriers, and the receiver device may perform HARQ combination on the initial transmission data and the retransmission data.

In some embodiments, the first information includes at least one of the following information: higher layer configuration information, physical layer information, or timer information. The higher layer configuration information is used to enable the multi-link HARQ combination. The physical layer information is used to activate the multi-link HARQ combination. The timer information is used to configure a timer, and the timer is configured to determine a time period for performing the multi-link HARQ combination. Alternatively, the timer information is used to configure a timer, and during running of the timer, the first apparatus performs the multi-link HARQ combination. Alternatively, the timer information is used to control a time period for performing the multi-link HARQ combination.

Herein, that the first information includes the higher layer configuration information and/or the physical layer information may also be understood as that the first information is carried in higher layer signaling and/or physical layer signaling, or the first information is the higher layer signaling and/or the physical layer signaling.

The timer information may be carried in higher layer signaling (namely, semi-static configuration), or may be carried in physical layer signaling (namely, dynamic configuration). The higher layer signaling herein and higher layer signaling used to enable the multi-link HARQ combination may be same higher layer signaling, or may be different higher layer signaling. Similarly, the physical layer signaling and physical layer signaling used to activate the multi-link HARQ combination may be same physical layer signaling, or may be different physical layer signaling.

A type of the higher layer signaling is not specifically limited in this disclosure. For example, the higher layer signaling may be radio resource control (RRC) signaling or medium access control (MAC) signaling.

A type of the physical layer signaling is not specifically limited in this disclosure. For example, the physical layer signaling may be scheduling information, control information, downlink control information (DCI), or receiving control information (RxCI).

The following describes the first information in detail.

Implementation 1: The first information includes the higher layer configuration information.

The higher layer configuration information indicates whether the multi-link HARQ combination is enabled. In other words, the first information is sent by using the higher layer signaling. Specifically, a network device sends the higher layer signaling to the first apparatus. The higher layer configuration information in the higher layer signaling indicates whether the multi-link HARQ combination of the first apparatus is enabled. For example, the third apparatus is the network device. The third apparatus may indicate, by using the RRC signaling, whether the multi-link HARQ combination is enabled. When the RRC signaling indicates that the multi-link HARQ combination is enabled, the first apparatus may perform the multi-link HARQ combination.

“Enable” herein may also be replaced with “activate”, “start”, or the like.

In the method 800, an example in which the higher layer configuration information indicates that the multi-link HARQ combination of the first apparatus is enabled is used. After the first apparatus receives the higher layer configuration information, the first apparatus may determine that the multi-link HARQ combination is enabled. That the first apparatus may determine that the multi-link HARQ combination is enabled may be understood as that when the first apparatus receives initial transmission data or retransmission data for same data through a plurality of links, the first apparatus may perform HARQ combination on the initial transmission data and the retransmission data from the plurality of links. A specific embodiment in which the first apparatus performs the HARQ combination on the data on the plurality of links is described in the following block 804.

In this way, related configuration for the multi-link HARQ combination is performed by using the higher layer configuration information, so that semi-static configuration for enabling or disabling the multi-link HARQ combination can be implemented, and a HARQ process number can be released in time. This helps avoid extension of transmission time caused by insufficient HARQ process numbers, and helps avoid an increase in a transmission latency and a reduction in reliability due to waiting for a HARQ process number. In addition, a resource of the physical layer signaling is usually more strained than that of the higher layer signaling resource. Sending the first information by using the higher layer signaling can reduce overheads of the physical layer signaling. This helps improve communication performance.

In this disclosure, there are a plurality of manners of configuring the higher layer configuration information. This is not specifically limited in this disclosure. The following manner 1 to manner 5 are several examples of the manners of configuring the higher layer configuration information. During implementation, at least one of the following manners may be used.

Manner 1: Configuration is performed for each terminal (namely, per UE).

In an example, the third apparatus may perform configuration at a granularity of a terminal. In this way, for different terminals, whether the multi-link HARQ combination is enabled may vary. For example, for a terminal #1, the third apparatus may configure that the multi-link HARQ combination is enabled; and for a terminal #2, the third apparatus may configure that the multi-link HARQ combination is disabled.

In this case, the plurality of links on which the HARQ combination is performed are links established by the first apparatus.

Service requirements of different terminals can be met in the manner 1.

Manner 2: Configuration is performed for each carrier (namely, per carrier).

In an example, the third apparatus may perform configuration at a granularity of a carrier. In this way, for different carriers, whether the multi-link HARQ combination is enabled may vary. For example, for a carrier #1, the third apparatus may configure that the multi-link HARQ combination is enabled; and for a carrier #2, the third apparatus may configure that the multi-link HARQ combination is disabled.

In this case, the plurality of links on which the HARQ combination is performed are links that are established by the first apparatus and that are used to transmit data on a carrier for which the multi-link HARQ combination is enabled.

Service requirements of different carriers can be met in the manner 2.

Manner 3: Configuration is performed for each HARQ process (namely, per HARQ process) or for each HARQ process group (namely, per HARQ process group).

In an example, the third apparatus may perform configuration at a granularity of a HARQ process or a HARQ process group. In this way, for different HARQ processes or different HARQ process groups, whether the multi-link HARQ combination is enabled may vary. For example, for a HARQ process #1, the third apparatus may configure that the multi-link HARQ combination is enabled; and for a HARQ process #2, the third apparatus may configure that the multi-link HARQ combination is disabled. For another example, for HARQ processes #1 to #3, the third apparatus may configure that the multi-link HARQ combination is enabled, and for HARQ processes #4 to #6, configure that the multi-link HARQ combination is disabled.

In this case, the plurality of links on which the HARQ combination is performed are links that are established by the first apparatus and that are used to transmit data of a HARQ process or a HARQ process group for which the multi-link HARQ combination is enabled.

Service requirements of different HARQ processes can be met in the manner 3.

Manner 4: Configuration is performed for each BWP (namely, per BWP).

In an example, the third apparatus may perform configuration at a granularity of a BWP. In this way, for different BWPs, whether the multi-link HARQ combination is enabled may vary. For example, for a BWP #1, the third apparatus may configure that the multi-link HARQ combination is enabled; and for a BWP #2, the third apparatus may configure that the multi-link HARQ combination is disabled.

In this case, the plurality of links on which the HARQ combination is performed are links that are established by the first apparatus and that are used to transmit data on a BWP for which the multi-link HARQ combination is enabled.

Service requirements of different BWPs can be met in the manner 4.

Manner 5: Configuration is performed for a combination of different dimensions.

In an example, the third apparatus may perform configuration at a granularity of any combination of a terminal, a carrier, a HARQ process, a HARQ process group, or a BWP. For example, the third apparatus may perform configuration per HARQ process, per carrier, and per terminal. For another example, the third apparatus may perform configuration per HARQ process and per terminal.

Service requirements of different terminals, different carriers, different HARQ processes, different HARQ processes groups, and/or different BWPs can be met in the manner 5.

Optionally, when the configuration is performed at the granularity of any combination of the terminal, the carrier, the HARQ process, a HARQ process group, or the BWP, if no configuration is performed for any combination of the terminal, the carrier, the HARQ process, a HARQ process group, or the BWP, the first apparatus may determine, in a predefined manner, whether the HARQ combination is enabled. For example, if no configuration is performed for any combination of the terminal, the carrier, the HARQ process, a HARQ process group, or the BWP, it is predefined that the HARQ process is disabled. Alternatively, if no configuration is performed for any combination of the terminal, the carrier, the HARQ process, a HARQ process group, or the BWP, it is predefined that the HARQ process is enabled.

Implementation 2: The first information includes the physical layer information.

The physical layer information indicates whether the multi-link HARQ combination is activated. In other words, the first information is sent by using the physical layer signaling. In an example, the third apparatus sends the physical layer signaling to the first apparatus. The physical layer information in the physical layer signaling indicates whether the multi-link HARQ combination of the first apparatus is activated. For example, the third apparatus indicates, by using scheduling information, whether a feature of the multi-link HARQ combination is activated. When the scheduling information indicates that the feature of the multi-link HARQ combination is activated, the first apparatus may perform the multi-link HARQ combination on data scheduled by using the scheduling information.

“Activate” herein may also be replaced with “enable”, “start”, or the like.

When the physical layer information indicates that the multi-link HARQ combination is activated, if data fails to be decoded, the first apparatus updates a buffer of the data, that is, stores currently received data (initial transmission data or retransmission data). When the physical layer information indicates that the multi-link HARQ combination is not activated, if data fails to be decoded, the first apparatus releases currently received data, that is, does not store the currently received data. In the foregoing manners, the first apparatus can flexibly process a data buffer, and requirements on a processing capability and a storage capability of the first apparatus are reduced.

In the method 800, an example in which the physical layer information indicates that the multi-link HARQ combination of the first apparatus is activated is used. After the first apparatus receives the physical layer information, the first apparatus may determine that the multi-link HARQ combination is activated. That the first apparatus may determine that the multi-link HARQ combination is activated may be understood as that when the first apparatus receives initial transmission data or retransmission data for same data through a plurality of links, the first apparatus may perform HARQ combination on the initial transmission data and the retransmission data from the plurality of links.

In this way, related configuration for the multi-link HARQ combination is performed by using the physical layer information, so that dynamic configuration for enabling or disabling the multi-link HARQ combination can be implemented, and a HARQ process number can be released in time. This helps avoid extension of transmission time caused by insufficient HARQ process numbers, so that decoding performance and HARQ combination efficiency are improved. In addition, compared with a manner in which the related configuration for the multi-link HARQ combination is performed by using the higher layer configuration information, the related configuration for the multi-link HARQ combination can be more flexibly performed in a more timely manner by using the physical layer information.

In this disclosure, the physical layer information may alternatively be used to enable the multi-link HARQ combination at a granularity of at least one of the following: a terminal, a carrier, a BWP, a HARQ process, and a HARQ process group.

In this disclosure, there are a plurality of implementations of the physical layer information. The following manner 1 and manner 2 are examples of the implementations of the physical layer information. During implementation, at least one of the following manners may be used.

Manner 1: The physical layer information is transmitted by using unicast physical layer signaling.

The unicast physical layer signaling may be scheduling information, control information, DCI, RxCI, or the like.

In this disclosure, the unicast physical layer signaling may mean that the physical layer signaling is sent for a communication device, and is, for example, user-level physical layer signaling, user-level control information, or user-level scheduling information.

In some embodiments, the unicast physical layer signaling may include a multi-link HARQ combination field, and the multi-link HARQ combination field indicates whether the multi-link HARQ combination is activated.

In an example, the multi-link HARQ combination field may be one bit, and two values of the bit may indicate whether the multi-link HARQ combination is activated or not. For example, if the bit is 1, it indicates that the multi-link HARQ combination is activated; or if the bit is 0, it indicates that the multi-link HARQ combination is not activated. For another example, if the bit is 0, it indicates that the multi-link HARQ combination is activated; or if the bit is 1, it indicates that the multi-link HARQ combination is not activated.

In some embodiments, an existing field in the unicast physical layer signaling may indicate whether the multi-link HARQ combination is activated.

In an example, the existing field in the unicast physical layer signaling may implicitly indicate whether the multi-link HARQ combination is activated. For example, a special value of a modulation and coding scheme (MCS), a transport block size (TBS), or a new data indicator (NDI) may indicate whether the multi-link HARQ combination is activated.

In another example, the existing field in the unicast physical layer signaling may explicitly indicate whether the multi-link HARQ combination is activated. For example, an NDI and the multi-link HARQ combination field jointly indicate whether the multi-link HARQ combination is activated. If the NDI and the multi-link HARQ combination field are 00, it indicates that the NDI is not flipped and the multi-link HARQ combination is not performed. If the NDI and the multi-link HARQ combination field are 11, it indicates that the NDI is flipped and the multi-link HARQ combination is performed.

Optionally, in the manner 1, the first apparatus may further determine whether the unicast physical layer signaling has the multi-link HARQ combination field, to detect the multi-link HARQ combination field in the unicast physical layer signaling.

In some embodiments, the third apparatus may further indicate, by using the higher layer signaling, whether the unicast physical layer signaling includes the multi-link HARQ combination field. In this way, the first apparatus may determine, based on the indication of the higher layer signaling, whether the unicast physical layer signaling includes the multi-link HARQ combination field. A manner in which the third apparatus indicates, by using the higher layer signaling, whether the unicast physical layer signaling includes the multi-link HARQ combination field is not specifically limited in this disclosure. For example, the third apparatus may perform configuration for DCI per carrier and per terminal.

Manner 2: The physical layer information is transmitted by using multicast physical layer signaling.

The multicast physical layer signaling may be group scheduling information, group control information, group DCI, group RxCI, or the like.

In this disclosure, the multicast physical layer signaling may mean that the physical layer signaling is sent for a group of communication devices, and is, for example, user group-level physical layer signaling, user group-level control information, or group common control information.

In some embodiments, dedicated multicast physical layer signaling indicates whether the multi-link HARQ combination is activated for communication devices or users in a group, where the communication devices or the users in the group include the first apparatus.

In an example, one communication device or user may correspond to one or more information blocks in the dedicated multicast physical layer signaling, and the one or more information blocks indicate whether the multi-link HARQ combination is activated for the communication device. A quantity of bits of the information block included in the dedicated multicast physical layer signaling may be predefined in a protocol, and is, for example, 1. Different values of the bit correspond to activation or deactivation. Optionally, a location of the information block corresponding to the communication device or the user in the dedicated multicast physical layer signaling may be configured by using higher layer signaling. Optionally, a quantity of information blocks included in the dedicated multicast physical layer signaling may be predefined in a protocol or configured by using higher layer signaling. For example, the quantity of information blocks included in the dedicated multicast physical layer signaling is predefined in the protocol or configured by using the higher layer signaling as 10 For another example, when a size of each information block is determined, a size of the dedicated multicast physical layer signaling, for example, 10 bits, may be predefined in the protocol or configured by using the higher layer signaling.

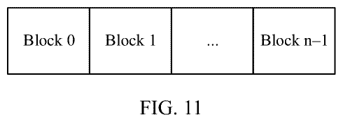

FIG. 11 is a diagram of dedicated multicast physical layer signaling according to this disclosure. As shown in FIG. 11, the dedicated multicast physical layer signaling includes n information blocks, and an information block 0 to an information block n−1 one-to-one correspond to a user 0 to a user n−1, where n is a positive integer.

In some embodiments, existing multicast physical layer signaling indicates whether the multi-link HARQ combination is activated for communication devices or users in a group, where the communication devices or the users in the group include the first apparatus.

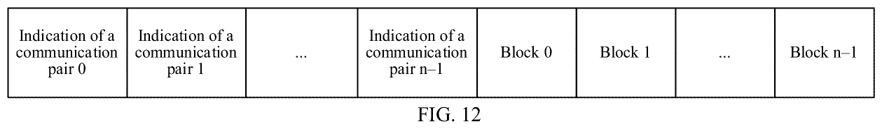

In an example, FIG. 12 is a diagram of multicast physical layer signaling according to this disclosure. A communication pair indication includes an identifier of a transmitter device and/or an identifier of a receiver device, or includes an identifier of a communication pair. An information block includes scheduling information and a multi-link HARQ combination field. A communication pair 0 to a communication pair n−1 one-to-one correspond to an information block 0 to an information block n−1.

A quantity of bits of the communication pair indication may be predefined in a protocol, or may be configured by the network device by using signaling. A quantity of information blocks may be predefined in a protocol, or may be configured by the network device by using signaling. A quantity of bits included in the information block may be predefined, or may be configured by the network device by using signaling.

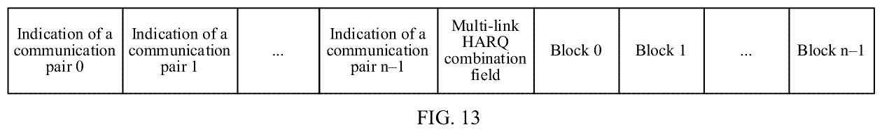

In another example, FIG. 13 is another diagram of multicast physical layer signaling according to this disclosure. A communication pair indication includes an identifier of a transmitter device and/or an identifier of a receiver device, or includes an identifier of a communication pair. A communication pair 0 to a communication pair n−1 one-to-one correspond to an information block 0 to an information block n−1. The information block 0 to the information block n−1 respectively include scheduling information of the corresponding communication pairs. A multi-link HARQ combination field corresponding to each of the communication pair 0 to the communication pair n−1 exclusively occupies one information block, that is, the multicast physical layer signaling includes one information block indicating whether the multi-link HARQ combination is activated for communication devices or users in a group.

Optionally, the communication pair 0 to the communication pair n−1 may correspond to n multi-link HARQ combination fields, that is, each communication pair may correspond to an independent multi-link HARQ combination field. For example, one information block includes n multi-link HARQ combination fields.

Optionally, the communication pair 0 to the communication pair n−1 may correspond to a same multi-link HARQ combination field, that is, a plurality of communication pairs may use an indication result of the same multi-link HARQ combination field. For example, one information block includes one multi-link HARQ combination field.

A quantity of bits of the communication pair indication may be predefined in a protocol, or may be configured by the network device by using signaling. A quantity of information blocks may be predefined in a protocol, or may be configured by the network device by using signaling. A quantity of bits included in the information block may be predefined, or may be configured by the network device by using signaling.

Implementation 3: The first information includes the timer information.

The timer information is used to configure the timer. During running of the timer, the first apparatus performs the multi-link HARQ combination. After the first apparatus receives the timer information, during running of the timer or in a timing period of the timer, the first apparatus receives initial transmission data or retransmission data for same data through a plurality of links, and the first apparatus may perform HARQ combination on the received data. Optionally, the timer information may further implicitly indicate that multi-link HARQ combination of the first apparatus is enabled. Optionally, if the retransmission data is not received within the time period indicated by the timer information, a buffer of the data is cleared. According to the solution, a HARQ process number can be released in time. This helps avoid extension of transmission time caused by insufficient HARQ process numbers. In addition, whether to perform the multi-link HARQ combination is determined based on effective time of the timer, so that signaling overheads can be reduced.

In this disclosure, there are a plurality of manners of configuring the timer information. This is not limited. The following manner 1, manner 2, manner 3, manner 4, and manner 5 are several examples of the manners of configuring the timer information. During implementation, at least one of the following manners may be used.

Manner 1: Configuration is performed for each terminal.

In an example, the third apparatus may perform configuration at a granularity of a terminal.

Different terminals may have different service features, and may correspond to a plurality of different links. In the manner of performing configuration per terminal, different timer information may be used for the plurality of different links corresponding to the different terminals, so that the different timer information is configured for different services.

Manner 2: Configuration is performed for each carrier.

In an example, the third apparatus may perform configuration at a granularity of a carrier.

Different services may be transmitted on different carriers, and the different carriers may correspond to a plurality of different links. In the manner of performing configuration per carrier, different timer information may be used for the plurality of different links corresponding to the different carriers, so that the different timer information is configured for the different services.

Manner 3: Configuration is performed for each BWP.

In an example, the third apparatus may perform configuration at a granularity of a BWP.

Different services may be transmitted on different BWPs, and different BWPs may correspond to a plurality of different links. In the manner of performing configuration per BWP, different timer information may be used for the plurality of different links corresponding to the different BWPs, so that the different timer information is configured for the different services.

Manner 4: Configuration is performed for each HARQ process or each HARQ process group.

In an example, the third apparatus may perform configuration at a granularity of a HARQ process or a HARQ process group.

Different HARQ processes or different HARQ process groups may have different service features, and may correspond to a plurality of different links. In the manner of performing configuration per HARQ process or per HARQ process group, different timer information may be used for the plurality of different links corresponding to the different HARQ processes or different HARQ process groups, so that the different timer information is configured for different services.

For example, a HARQ process number #1 corresponds to an ultra-short-latency service, and the timer information may indicate 0.5 ms.

For another example, a HARQ process number #2 corresponds to a short-latency service, and the timer information may indicate 1 ms.

For another example, a HARQ process number #3 corresponds to a medium-latency service, and the timer information may indicate 5 ms.

For another example, a HARQ process number #4 corresponds to a long-latency service, and the timer information may indicate 10 ms.

For another example, HARQ process numbers #1 to #4 correspond to ultra-short-latency services, and the timer information may indicate 0.5 ms.

For another example, HARQ process numbers #5 to #8 correspond to short-latency services, and the timer information may indicate 1 ms.

For another example, HARQ process numbers #5 to #8 correspond to medium-latency services, and the timer information may indicate 5 ms.

For another example, HARQ process numbers #9 to #16 correspond to long-latency services, and the timer information may indicate 10 ms.

Manner 5: Configuration is performed for a combination of different dimensions.

In an example, the third apparatus may perform configuration at a granularity of any combination of a terminal, a carrier, a BWP, a HARQ process, and a HARQ process group, so that different timer information is configured for different services.

Optionally, when the timer is configured at the granularity of any combination of the terminal, the carrier, the HARQ process, the HARQ process group, or the BWP, if no configuration is performed for any combination of the terminal, the carrier, the HARQ process, the HARQ process group, or the BWP, the timer for the HARQ combination may be determined in a predefined manner. For example, if no configuration is performed for any combination of the terminal, the carrier, the HARQ process, the HARQ process group, or the BWP, the timer for the HARQ combination is predefined as x ms, for example, 5 ms. Alternatively, if no configuration is performed for any combination of the terminal, the carrier, the HARQ process, the HARQ process group, or the BWP, the timer for the HARQ combination is predefined as a quantity y2 of symbols/slots/subframes at a subcarrier spacing y1. For example, the quantity of slots at 30 kHz is 2.

In this disclosure, the timer information may be carried in higher layer signaling (namely, semi-static configuration), or may be carried in physical layer signaling (namely, dynamic configuration). The higher layer signaling herein and the higher layer signaling used to enable the multi-link HARQ combination may be same higher layer signaling, or may be different higher layer signaling. Similarly, the physical layer signaling and the physical layer signaling used to enable the multi-link HARQ combination may be same physical layer signaling, or may be different physical layer signaling.

In this disclosure, the timer information may include at least one of the following: duration of the timer, a start moment of the timer, or a stop condition of the timer. The duration of the timer, the start moment of the timer, and the stop condition of the timer may be explicitly or implicitly indicated by using one piece of signaling, or may be explicitly or implicitly indicated by using different signaling. When the timer information does not include the start moment of the timer and/or the stop condition of the timer, the start moment of the timer and/or the stop condition of the timer may be predefined or preconfigured.

### (1) Duration of the Timer

In some embodiments, the timer information may indicate the duration of the timer by indicating absolute time.

For example, the timer information may indicate 1 ms, 0.5 ms, or 0.25 ms.

In some embodiments, the timer information may indicate a subcarrier spacing (SCS) and a quantity of symbols and/or a quantity of slots and/or a quantity of subframes corresponding to the SCS.

For example, the timer information indicates that the subcarrier spacing is 15 kHz, and the quantity of symbols corresponding to 15 kHz is S11, the quantity of slots corresponding to 15 kHz is L11, and/or the quantity of subframes corresponding to 15 kHz is T11, where S11, L11, and T11 are positive integers.

For another example, the timer information indicates that the subcarrier spacing is 30 kHz, and the quantity of symbols corresponding to 30 kHz is S12, the quantity of slots corresponding to 30 kHz is L12, and/or the quantity of subframes corresponding to 30 kHz is T12, where S12, L12, and T12 are positive integers.

### (2) Start Moment of the Timer

In this disclosure, there are a plurality of manners of determining the start moment of the timer. This is not specifically limited in this disclosure. The following manner 1, manner 2, and manner 3 are examples of the manners of determining the start moment of the timer.

Manner 1: The start moment of the timer is determined based on received physical layer information.

The start moment of the timer may be a start moment or an end moment of the physical layer information. The start moment or the end moment of the physical layer information may be an absolute moment, for example, an absolute moment at which receiving of the physical layer information starts or receiving of the physical layer information is completed, or an absolute moment at which decoding of the physical layer information starts or decoding of the physical layer information is completed. The start moment or the end moment of the physical layer information may alternatively be a start time unit or an end time unit of the physical layer information. The time unit herein may be, for example, a symbol, a slot, a subframe, or a frame.

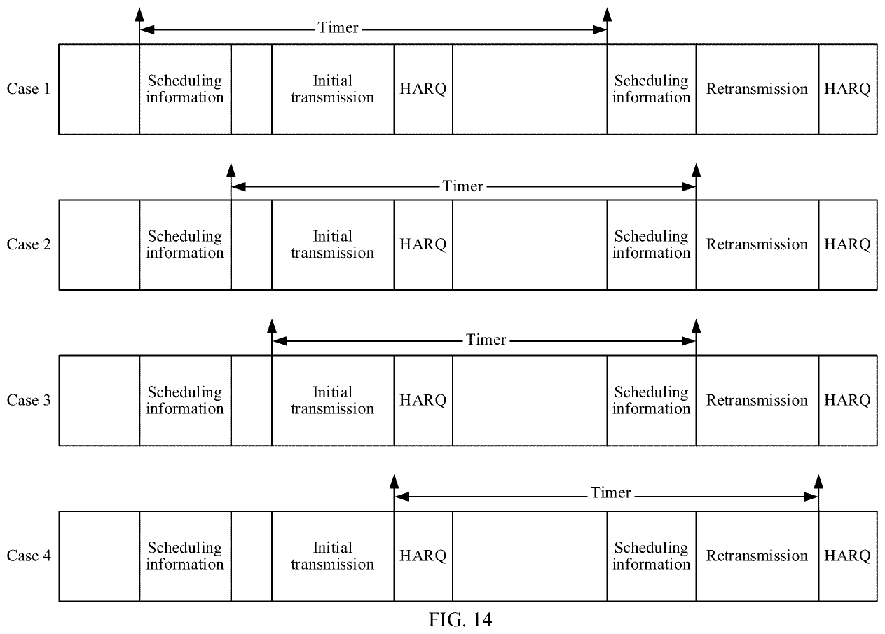

FIG. 14 is a diagram of a start moment of a timer. In FIG. 14, an example in which the physical layer information is scheduling information is used for description.

As shown in a case 1 in FIG. 14, the start moment of the timer may be a start symbol of the physical layer information. As shown in a case 2 in FIG. 14, the start moment of the timer may be an end symbol of the physical layer information.

Manner 2: The start moment of the timer is determined based on initial transmission data.

The start moment of the timer may be a start moment or an end moment of the initial transmission data. The start moment or the end moment of the initial transmission data may be an absolute moment, for example, an absolute moment at which receiving of the initial transmission data starts or receiving of the initial transmission data is completed, or an absolute moment at which decoding of the initial transmission data starts or decoding of the initial transmission data is completed. The start moment or the end moment of the initial transmission data may alternatively be a start time unit or an end time unit of the initial transmission data. The time unit herein may be, for example, a symbol, a slot, a subframe, or a frame.

With reference to FIG. 14, as shown in a case 3 in FIG. 14, the start moment of the timer may be a start symbol of the initial transmission data. As shown in a case 4 in FIG. 14, the start moment of the timer may be an end symbol of the initial transmission data.

Manner 3: The start moment of the timer is determined based on a time domain position of a resource that is used to transmit feedback information and that is indicated in the physical layer information.

The feedback information is used to feed back whether data is successfully received. For example, the feedback information is an ACK or a NACK. The resource used to transmit the feedback information may be a resource of uplink control information (UCI), a resource of a PUCCH, a resource of sidelink control information (SCI), a resource of a physical transmission link control channel (PTxCCH), a resource of physical feedback control channel (PFCCH), or the like. The resource used to transmit the feedback information is referred to as a feedback resource in the following.

The start moment of the timer may be a start moment or an end moment of the feedback resource. The start moment or the end moment of the feedback resource may be a start time unit or an end time unit of the feedback resource. The time unit herein may be, for example, a symbol, a slot, a subframe, or a frame.

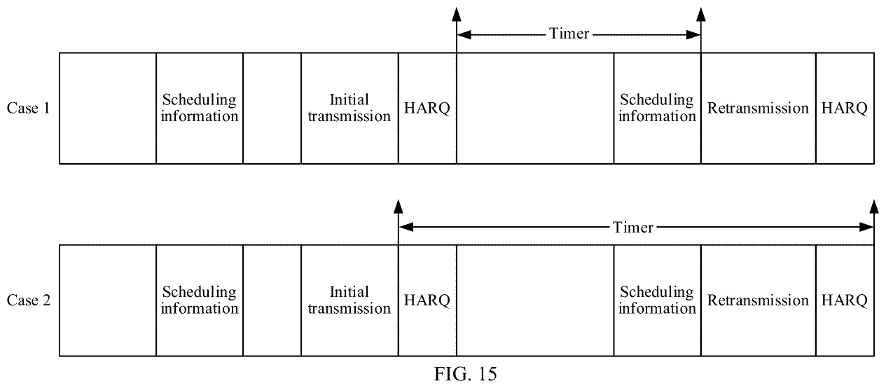

FIG. 15 is another diagram of a start moment of a timer.

As shown in a case 1 in FIG. 15, the start moment of the timer may be an end symbol of HARQ transmission. As shown in a case 2 in FIG. 15, the start moment of the timer may be a start symbol of HARQ transmission.

### (3) Stop Condition of the Timer

In this disclosure, the timer may stop running (also referred to as “stop timing”) when at least one of the following conditions is met: the timer expires (also referred to as “times out”), or data decoding succeeds. A moment at which data decoding succeeds may correspond to a moment at which the first apparatus starts to send an ACK, a moment at which the first apparatus completes sending of the ACK, or a moment at which the first apparatus completes data decoding.

When the timer is configured in the first apparatus, the first apparatus may determine, in at least one of the following manners, that the HARQ combination needs to be performed.

Manner 1: It is determined, based on physical layer information, that the HARQ combination needs to be performed.

In an example, if scheduling information for retransmission data is received within the effective time of the timer, HARQ combination may be performed on initial transmission data and the retransmission data.

For example, when the effective time of the timer includes a time unit of the scheduling information for the retransmission data, the HARQ combination may be performed on the initial transmission data and the retransmission data.

For another example, as shown in the case 1 in FIG. 14, the first apparatus determines to perform the HARQ combination when starting to receive the scheduling information used to schedule the retransmission data. In this case, when receiving the retransmission data scheduled by using the scheduling information, the first apparatus may perform the HARQ combination on the initial transmission data and the retransmission data.

For another example, as shown in the case 2 in FIG. 14, the first apparatus determines to perform the HARQ combination when completing receiving of the scheduling information used to schedule the retransmission data. In this case, when receiving the retransmission data scheduled by using the scheduling information, the first apparatus may perform the HARQ combination on the initial transmission data and the retransmission data.

Manner 2: It is determined, based on retransmission data, that the HARQ combination needs to be performed.

In an example, if retransmission data is received within the effective time of the timer, HARQ combination may be performed on initial transmission data and the retransmission data.

For example, when the effective time of the timer includes a time unit for transmitting the retransmission data, the HARQ combination may be performed on the initial transmission data and the retransmission data.

For another example, as shown in the case 3 in FIG. 14, the first apparatus determines to perform the HARQ combination when starting to receive retransmission data. In this case, after completing receiving of the retransmission data, the first apparatus may perform the HARQ combination on initial transmission data and the retransmission data.

For another example, as shown in the case 4 in FIG. 14, the first apparatus determines to perform the HARQ combination when completing receiving of the retransmission data. In this case, the first apparatus may perform the HARQ combination on the initial transmission data and the retransmission data.

Manner 3: It is determined, based on feedback information, that the HARQ combination needs to be performed.

In an example, if feedback information for retransmission data may be fed back within the effective time of the timer, HARQ combination may be performed on initial transmission data and the retransmission data.

For example, when the effective time of the timer includes a time unit used to send the feedback information for the retransmission data, the HARQ combination may be performed on the initial transmission data and the retransmission data. The time unit used to send the feedback information for the retransmission data may be a time unit of a feedback resource indicated in scheduling information for the retransmission data.

For another example, as shown in the case 2 in FIG. 15, when determining, based on scheduling information, that a HARQ of the retransmission data may be fed back within the effective time of the timer, the first apparatus may perform the HARQ combination on the initial transmission data and the retransmission data. In this case, after completing receiving of the retransmission data, the first apparatus may perform the HARQ combination on the initial transmission data and the retransmission data.

Implementation 4: The first information includes the higher layer configuration information and the physical layer information.

The higher layer configuration information indicates whether the multi-link HARQ combination is enabled. The physical layer information indicates whether the multi-link HARQ combination is activated. In other words, the first information includes the higher layer configuration information sent by using the higher layer signaling and the physical layer information sent by using the physical layer signaling. For example, the third apparatus indicates, by using RRC signaling, whether the multi-link HARQ combination is enabled, and indicates, by using scheduling information, whether a feature of the multi-link HARQ combination is activated. When the RRC signaling indicates that the multi-link HARQ combination is enabled, and the scheduling information indicates that the feature of the multi-link HARQ combination is activated, the first apparatus may perform the multi-link HARQ combination on data scheduled by using the scheduling information.

In some embodiments, when the first apparatus receives the higher layer configuration information but does not receive the physical layer information, the first apparatus may determine, based on the higher layer configuration information, whether to perform the multi-link HARQ combination. When the first apparatus receives the higher layer configuration information and the physical layer information, the first apparatus may determine, based on the physical layer information, whether to perform the multi-link HARQ combination. Generally, a sending frequency of the higher layer signaling is lower than a sending frequency of the physical layer signaling. Therefore, compared with a solution in which whether to perform the multi-link HARQ combination is determined based only on the higher layer configuration information, this solution helps adapt to a service change, and compared with a solution in which whether to perform the multi-link HARQ combination is determined based only on the physical layer information, this solution helps reduce signaling overheads.

For an implementation of the higher layer configuration information in the implementation 4, refer to the implementation 1. Details are not described herein again. For an implementation of the physical layer information in the implementation 4, refer to the implementation 2. Details are not described herein again. A difference lies in that the first apparatus may further determine, based on a HARQ process number and/or a carrier, whether unicast DCI includes a multi-link HARQ combination field. In an example, the first apparatus may determine, based on a HARQ process number and/or a number of a carrier for which a multi-link HARQ combination function is enabled and that is indicated in the higher layer configuration information, and a HARQ process number and/or a number of a carrier that is indicated in the physical layer information, whether unicast physical layer signaling includes a multi-link HARQ combination field. For example, RRC signaling received by the first apparatus indicates that the multi-link HARQ combination is enabled for a HARQ process number #1. If DCI received by the first apparatus includes the HARQ process number #1, the first apparatus determines that the DCI includes a multi-link HARQ combination field. If the DCI received by the first apparatus includes a HARQ process number #2, the first apparatus determines that the DCI does not include the multi-link HARQ combination field. In this solution, a total quantity of blind detected bits in the DCI remains unchanged, but a meaning of a field in the DCI changes, and a quantity of reserved bits in the DCI varies.

Implementation 5: The first information includes the higher layer configuration information and the timer information.

The higher layer configuration information indicates whether the multi-link HARQ combination is enabled. The timer information is used to configure the timer, and the timer is configured to determine the time period for performing the multi-link HARQ combination. In other words, the first information includes the higher layer configuration information sent by using the higher layer signaling and the timer information sent by using the higher layer signaling and/or the physical layer signaling.

In an example, the third apparatus indicates, by using RRC signaling, whether the multi-link HARQ combination is enabled. When the RRC signaling indicates that the multi-link HARQ combination is enabled, during running of the timer, the first apparatus may perform the multi-link HARQ combination on data scheduled by using scheduling information.

For configuration of the higher layer configuration information in the implementation 5, refer to the implementation 1, and for configuration of the timer information in the implementation 5, refer to the implementation 3. Details are not described herein again.

According to the solution, a HARQ process number can be released in time. This helps avoid extension of transmission time caused by insufficient HARQ process numbers.

Implementation 6: The first information includes the physical layer information and the timer information.

The physical layer information indicates whether the multi-link HARQ combination is activated. The timer information is used to configure the timer, and the timer is configured to determine the time period for performing the multi-link HARQ combination. In other words, the first information includes the physical layer information sent by using the physical layer signaling and the timer information sent by using the higher layer signaling and/or the physical layer signaling.

In an example, the third apparatus indicates, by using scheduling information, whether a feature of the multi-link HARQ combination is activated. When the scheduling information indicates that the feature of the multi-link HARQ combination is activated, during running of the timer, the first apparatus may perform the multi-link HARQ combination on data scheduled by using the scheduling information.

For configuration of the physical layer information in the implementation 6, refer to the implementation 2 and the implementation 4, and for configuration of the timer information in the implementation 6, refer to the implementation 3. Details are not described herein again.

Implementation 7: The first information includes the higher layer configuration information, the physical layer information, and the timer information.

The higher layer configuration information indicates whether the multi-link HARQ combination is enabled. The physical layer information indicates whether the multi-link HARQ combination is activated. The timer information is used to configure the timer, and the timer is configured to determine the time period for performing the multi-link HARQ combination. In other words, the first information includes the higher layer configuration information sent by using the higher layer signaling, the physical layer information sent by using the physical layer signaling, and the timer information sent by using the higher layer signaling and/or the physical layer signaling.

In an example, the third apparatus indicates, by using RRC signaling, whether the multi-link HARQ combination is enabled, and indicates, by using scheduling information, whether a feature of the multi-link HARQ combination is activated. When the RRC signaling indicates that the multi-link HARQ combination is enabled, and the scheduling information indicates that the feature of the multi-link HARQ combination is activated, during running of the timer, the first apparatus may perform the multi-link HARQ combination on data scheduled by using the scheduling information.

For example, for data of a HARQ process number #1 scheduled by using the scheduling information, it should be noted that this example is applicable to any implementation in which the timer information is configured for the first apparatus.

(1) If initial transmission data fails to be decoded, a buffer of the HARQ process number #1 is updated (that is, the initial transmission data is stored), and the timer is started.

(2) If the first apparatus receives retransmission data of the HARQ process number #1 from different links during running of the timer, the first apparatus performs HARQ combination on initial transmission data and the retransmission data.

(3) If the first apparatus does not receive the retransmission data of the HARQ process number #1 from different links during running of the timer, the first apparatus releases the data (namely, the buffer of the HARQ process number #1).

According to the solution, a HARQ process number can be released in time. This helps avoid extension of transmission time caused by insufficient HARQ process numbers.

For configuration of the higher layer configuration information in the implementation 7, refer to the implementation 1, for configuration of the physical layer information in the implementation 7, refer to the implementation 2 and the implementation 4, and for configuration of the timer information in the implementation 7, refer to the implementation 3. Details are not described herein again.

It should be noted that the higher layer configuration information, the physical layer information, and the timer information included in the first information may be configured by using different signaling, or may be partially or completely configured by using one piece of signaling. For example, the higher layer configuration information and the timer information may be configured by using a same piece of signaling. For another example, the physical layer information and the timer information may be configured by using a same piece of signaling.

Block 802: The first apparatus receives first data from a first link.

As shown in FIG. 8, the first link is a link between the first apparatus and the second apparatus, that is, the first apparatus receives the first data from the second apparatus, and correspondingly, the second apparatus sends the first data to the first apparatus. The first data is initial transmission data or retransmission data for third data.

Optionally, the second apparatus may be a terminal. When the second apparatus is the terminal, the network device may schedule the second apparatus to send the first data to the first apparatus. The first data may be data prestored in the second apparatus, may be received by the second apparatus from the network device, or may be determined by the second apparatus based on the third data that has been successfully received. In an example, the network device may send first scheduling information to the second apparatus, where the first scheduling information is used to schedule the second apparatus to send the first data to the first apparatus; and the network device may send second scheduling information to the first apparatus, where the second scheduling information is used to schedule the first apparatus to receive the first data from the second apparatus. The second scheduling information may include a HARQ process number of the first data, so that the first apparatus performs HARQ combination based on the HARQ process number. Optionally, the first scheduling information and the second scheduling information may be same scheduling information.

Optionally, the second apparatus may be a network device. When the second apparatus is the network device, the first data may be determined by the second apparatus and sent to the first apparatus, or the first data may be from another network device or terminal. In an example, the second apparatus may send third scheduling information to the first apparatus, where the third scheduling information is used to schedule the first apparatus to receive the first data from the second apparatus. The third scheduling information may include a HARQ process number of the first data, so that the first apparatus performs HARQ combination based on the HARQ process number.

When the third apparatus is a network device, the network device herein may be the third apparatus, or certainly may be another network device.

Block 803: The first apparatus receives second data from a second link.

As shown in FIG. 8, the second link is a link between the first apparatus and the third apparatus, that is, the first apparatus receives the second data from the third apparatus, and correspondingly, the third apparatus sends the second data to the first apparatus. The second data is retransmission data for the third data.

Optionally, the third apparatus may be a terminal. When the third apparatus is the terminal, the network device may schedule the third apparatus to send the second data to the first apparatus. The second data may be data prestored in the third apparatus, may be received by the third apparatus from the network device, or may be determined by the third apparatus based on the third data that has been successfully received. In an example, the network device may send fourth scheduling information to the third apparatus, where the fourth scheduling information is used to schedule the third apparatus to send the second data to the first apparatus; and the network device may send fifth scheduling information to the first apparatus, where the fifth scheduling information is used to schedule the first apparatus to receive the second data from the third apparatus. The fifth scheduling information may include a HARQ process number of the second data, so that the first apparatus performs HARQ combination based on the HARQ process number. Optionally, the fourth scheduling information and the fifth scheduling information may be same scheduling information.

Optionally, the third apparatus may be a network device. When the third apparatus is the network device, the second data may be determined by the third apparatus and sent to the first apparatus, or the second data may be from another network device or terminal. In an example, the third apparatus may send sixth scheduling information to the first apparatus, where the sixth scheduling information is used to schedule the first apparatus to receive the second data from the third apparatus. The sixth scheduling information may include a HARQ process number of the second data, so that the first apparatus performs HARQ combination based on the HARQ process number.

When the third apparatus is a network device, the network device herein may be the third apparatus, or certainly may be another network device.

According to the foregoing content, both the first data in block 802 and the second data in block 803 are for the third data, that is, the first data and the second data are the initial transmission data or the retransmission data for the same data.

In addition, it should be noted that for the first apparatus, the initial transmission data and the retransmission data may be received sequentially, or may be received simultaneously. This is not limited in this disclosure. In addition, in this disclosure, the initial transmission data is for one piece of data. Generally, the initial transmission data is first received, and then the retransmission data is received. When the initial transmission data and the retransmission data are received simultaneously, the initial transmission data and the retransmission data may be distinguished, or both the data may be used as initial transmission data, or both the data may be used as retransmission data. This is not limited in this disclosure. A focus of the technical solutions of this disclosure is to perform HARQ combination on transmission of same data on different links. Specifically, which data is the initial transmission data and which data is the retransmission data do not constitute a limitation on the solutions of this disclosure.

Block 804: The first apparatus performs HARQ combination on the first data and the second data based on the first information.

The following embodiments describe a numbering manner of a HARQ process number of a link, and may be used as independent embodiments, or may be combined with another embodiment in this disclosure. This is not limited herein.

In some embodiments, HARQ process numbers of a plurality of links may be unified in a joint numbering manner. That the plurality of links use joint numbering may be understood as that the plurality of links use a same set of HARQ process numbers. For example, the plurality of links jointly use 16 HARQ process numbers whose numbers are 0 to 15. In this way, for initial transmission or retransmission of same data, same HARQ process numbers are used on the plurality of links.

In an example, for a user that does not support carrier aggregation, joint numbering may be performed on HARQ process numbers of a plurality of links of one carrier. For example, a protocol may define or the network device may configure that a total quantity of available HARQ process numbers does not exceed Nₘₐₓ. A value of Nₘₐₓ may be 16, 32, or the like. A specific value of Nₘₐₓ is not limited in this disclosure.

In an example, for a user that supports carrier aggregation, joint numbering may be performed on HARQ process numbers of a plurality of links of a plurality of carriers. For example, a protocol may define or the network device may configure that a total quantity of available HARQ process numbers does not exceed Nₘₐₓ. A value of Nₘₐₓ may be 32, 48, or the like. A specific value of Nₘₐₓ is not limited in this disclosure.

When the first link and the second link use the joint numbering, that the first apparatus performs the HARQ combination on the first data and the second data includes: The first apparatus performs the HARQ combination when a first HARQ process number of the first data is the same as a second HARQ process number of the second data, that is, the first apparatus performs the HARQ combination on the data on the first link and the second link that have a same HARQ process number.

Specifically, the first apparatus determines, based on the first information, to combine the data on the first link and the data on the second link. When receiving the second data through the second link, the first apparatus performs the HARQ combination on the first data and the second data based on the HARQ process number of the second data, where the first data is data in a HARQ buffer of the HARQ process number.

In this disclosure, optionally, to reduce a requirement on a processing capability of the first apparatus or adapt to a first apparatus having a weak processing capability, the first apparatus does not expect to schedule data of more than N1 HARQ processes on one carrier in a period of time. N1 is a positive integer. For example, a value of N1 is 8.

In this disclosure, optionally, to reduce a requirement on a processing capability of the first apparatus or adapt to a first apparatus having a weak processing capability, the first apparatus does not expect to schedule data of more than N2 HARQ processes on a plurality of carriers in a period of time. N2 is a positive integer. For example, a value of N2 is 8 or 16. The plurality of carriers may be all supported carriers, or may be a group of supported carriers.

Optionally, whether joint numbering is used and/or a link using joint numbering may be predefined or preconfigured.

Optionally, whether joint numbering is used and/or a link using joint numbering may be dynamically configured. For example, as shown in FIG. 8, for the implementation, the method 800 may further include block 805.

Block 805: The first apparatus receives third information.

The third information indicates the link using joint numbering, and/or the third information indicates whether the joint numbering is enabled.

In some embodiments, the first apparatus receives the third information from the third apparatus. Correspondingly, the third apparatus sends the third information to the first apparatus.

Optionally, an apparatus sending the third information may be an apparatus sending data or may not be the apparatus sending the data.

Optionally, an apparatus sending the third information may be an apparatus sending the first information or may not be the apparatus sending the first information.

Optionally, the third information may be carried in higher layer signaling.

In the method 800, an example in which links using joint numbering include the first link and the second link, and/or the joint numbering is enabled is used.

In this disclosure, there are a plurality of manners of configuring the joint numbering. This is not limited. The following manner 1 to manner 3 are several examples of the manners of configuring the joint numbering. During implementation, at least one of the following manners may be used.

Manner 1: Configuration is performed for each carrier.

That is, configuration may be performed at a granularity of a carrier. In this way, for different carriers, whether the joint numbering is enabled may vary. For example, for a carrier #1, that the joint numbering is enabled may be configured; and for a carrier #2, that the joint numbering is disabled may be configured.

In an example, the third apparatus may configure, by using the third information, that the joint numbering is enabled for some carriers. For example, when data transmission on some carriers has a special requirement, the third apparatus may configure that the joint numbering is disabled for the carriers, that is, the carriers use independent numbering. For another example, for carriers in a THz frequency band scenario and an ultra-high frequency scenario, the third apparatus may configure that the joint numbering is disabled for the carriers, that is, the carriers use independent numbering. In this way, service requirements of different carriers can be met.

In the manner 1, a link of a carrier using the joint numbering is the link using joint numbering.

Manner 2: Configuration is performed for each link.

That is, configuration may be performed at a granularity of a link. In this way, for different links, whether the joint numbering is enabled may vary. For example, for a link #1, that the joint numbering is enabled may be configured; and for a link #2, that the joint numbering is disabled may be configured.

In an example, the third apparatus may configure, by using the third information, that the joint numbering is enabled for some links. For example, when data transmission on some links has a special requirement, the third apparatus may configure that the joint numbering is disabled for the links, that is, the links use independent numbering. For another example, for links in a THz frequency band scenario and an ultra-high frequency scenario, the third apparatus may configure that the joint numbering is disabled for the links, that is, the links use independent numbering. In this way, service requirements of different links can be met.

Manner 3: Configuration is performed for a combination of different dimensions.

In an example, configuration may be performed at a granularity of a combination of a carrier and a link. For example, the third apparatus may perform configuration per link and per carrier by using the third information.

Optionally, when whether the joint numbering is performed on HARQ process numbers is configured at a granularity of any combination of a carrier or a link, if no configuration is performed for any combination of the carrier or the link, whether the joint numbering is performed on the HARQ process numbers may be determined in a predefined manner. For example, if no configuration is performed for any combination of the carrier or the link, that the joint numbering is enabled for HARQ process numbers (that is, the joint numbering is used) is predefined. Alternatively, if no configuration is performed for any combination of the carrier or the link, that the joint numbering is disabled for HARQ process numbers (that is, the joint numbering is not used) is predefined.

In some embodiments, HARQ process numbers used to transmit same data on a plurality of links may be associated. In this case, the plurality of links may use independent numbering. That the plurality of links may use independent numbering may be understood as that each of the plurality of links corresponds to one group of HARQ process numbers.

When the first link and the second link use the independent numbering, if the first apparatus performs the HARQ combination on the first data and the second data, a first HARQ process number of the first data needs to be associated with a second HARQ process number of the second data, that is, the first apparatus performs the HARQ combination on data whose HARQ process numbers have an association relationship and that is on the first link and the second link. The first HARQ process number of the first data and the second HARQ process number of the second data may be the same or may be different.

Specifically, the first apparatus determines, based on the first information, to combine the data on the first link and the data on the second link. When receiving the second data through the second link, the first apparatus performs the HARQ combination on the second data and the first data based on the HARQ process number of the second data, where the first data is data whose HARQ process number has an association relationship with the HARQ process number in a HARQ buffer.

It should be noted that HARQ process numbers having an association relationship may be the same or may be different. For example, a HARQ process number 1 of the first link is associated with a HARQ process number 1 of the second link. For another example, a HARQ process number 1 of the first link is associated with a HARQ process number 3 of the second link.

Optionally, the association relationship between the HARQ process numbers may be predefined or preconfigured. The HARQ process numbers having the association relationship include the HARQ process number of the first data and the HARQ process number of the second data.

Optionally, the association relationship between the HARQ process numbers may be dynamically configured. The HARQ process numbers having the association relationship include the HARQ process number of the first data and the HARQ process number of the second data. For example, as shown in FIG. 8, for the implementation, the method 800 may further include block 806.

Block 806: The first apparatus receives fourth information.

The fourth information indicates HARQ process numbers having an association relationship.

In some embodiments, the first apparatus receives the fourth information from the third apparatus. Correspondingly, the third apparatus sends the fourth information to the first apparatus.

Optionally, an apparatus sending the fourth information may be an apparatus sending data or may not be the apparatus sending the data.

Optionally, an apparatus sending the fourth information may be an apparatus sending the first information or may not be the apparatus sending the first information.

In this way, according to the method 800, the first apparatus can implement the multi-link HARQ combination. In this way, when a transmission latency is reduced and transmission reliability is improved through dynamical switching between the plurality of links, a communication performance gain (including a latency gain and a reliability gain) brought by the HARQ combination can be retained, to help reduce the transmission latency and improve the transmission reliability.

In some other embodiments of this disclosure, the method 800 may further include block 807.

Block 807: The first apparatus reports second information.

The second information indicates a capability related to the HARQ combination.

In some embodiments, the first apparatus sends the second information to the third apparatus. Correspondingly, the third apparatus receives the second information from the first apparatus. Optionally, in this case, the third apparatus may perform related configuration for the HARQ combination on the first apparatus based on the second information reported by the first apparatus. For example, the third apparatus determines the first information based on the second information reported by the first apparatus.

Optionally, an apparatus receiving the second information may be an apparatus sending data or may not be the apparatus sending the data.

Optionally, an apparatus receiving the second information may be an apparatus sending the first information or may not be the apparatus sending the first information.

The capability related to the HARQ combination includes a multi-link HARQ combination capability and/or a buffer capability.

The multi-link HARQ combination capability includes at least one of the following:

### (1) Whether Multi-Link HARQ Combination of a Single Carrier is Supported

For example, when the first apparatus supports the multi-link HARQ combination of the single carrier, the third apparatus may schedule the first data and the second data to be transmitted on a same carrier. The first apparatus may report, per carrier, whether the multi-link HARQ combination of the single carrier is supported. For example, the first apparatus reports, for one or more carriers, a capability of whether the multi-link HARQ combination is supported. The third apparatus may determine, for the first apparatus based on a carrier for which the first apparatus reports supporting the multi-link HARQ combination of the single carrier, the first information to be sent to the first apparatus. A carrier used by a link for which the first information indicates that the multi-link HARQ combination is enabled is the carrier for which the first apparatus reports supporting the multi-link HARQ combination of the single carrier.

### (2) Whether Multi-Link HARQ Combination of a Plurality of Carriers is Supported

For example, when the first apparatus supports the multi-link HARQ combination of the plurality of carriers, the third apparatus may schedule the first data and the second data to be transmitted on a same carrier or different carriers. The first may report, per carrier or per carrier group, whether the multi-link HARQ combination of the plurality of carriers is supported. For example, the first apparatus reports, for one or more carriers or one or more carrier groups, a capability of whether the multi-link HARQ combination is supported. The third apparatus may determine, for the first apparatus based on a carrier for which the first apparatus reports supporting the multi-link HARQ combination of the plurality of carriers, the first information to be sent to the first apparatus. A carrier used by a link for which the first information indicates that the multi-link HARQ combination is enabled is the carrier for which the first apparatus reports supporting the multi-link HARQ combination of the plurality of carriers.

### (3) Whether Multi-Link HARQ Combination of a Same SCS is Supported

For example, when the first apparatus supports the multi-link HARQ combination of the same SCS, the first data and the second data have a same subcarrier spacing.

### (4) Whether Multi-Link HARQ Combination of Different SCSs is Supported.

For example, when the first apparatus supports the multi-link HARQ combination of the different SCSs, the first data and the second data have a same subcarrier spacing or different subcarrier spacings.

### (5) Whether Enabling of Multi-Link HARQ Combination of Semi-Static Configuration is Supported

For example, when the first apparatus supports enabling of the multi-link HARQ combination of the semi-static configuration, the third apparatus may send the first information to the first apparatus by using the higher layer signaling. In other words, the third apparatus may indicate, by using the higher layer signaling, whether the multi-link HARQ combination is enabled.

### (6) Whether Activation of Multi-Link HARQ Combination of Dynamic Configuration is Supported

For example, when the first apparatus supports enabling of the multi-link HARQ combination of the dynamic configuration, the third apparatus may send the first information to the first apparatus by using the physical layer signaling. In other words, the third apparatus may indicate, by using the physical layer signaling, whether the multi-link HARQ combination is activated.

### (7) Whether Enabling of Timer-Based Multi-Link HARQ Combination is Supported

For example, when the first apparatus supports enabling of the timer-based multi-link HARQ combination, the third apparatus may configure the timer for the first apparatus by using the first information. The timer is configured to determine the time period for performing the multi-link HARQ combination.

The buffer capability includes duration for which data can be buffered. The duration may be absolute duration, or may be an occupied time unit. The time unit herein may be, for example, a symbol, a slot, a subframe, or a frame. For example, the first apparatus may report that the duration for which data can be buffered is 0.5 ms, 1 ms, 5 ms, or 10 ms. For another example, the first apparatus may report that the duration for which data can be buffered is seven symbols, N3 symbols, one slot, or N4 slots, where N3 and N4 are greater than 0.

If the first apparatus reports the buffer capability to the third apparatus, the third apparatus may perform scheduling and configuration based on the buffer capability of the first apparatus. For example, the third apparatus schedules data retransmission within the duration for which data can be buffered and that is reported by the first apparatus. For another example, the third apparatus determines, based on the duration for which data can be buffered and that is reported by the first apparatus, a time period for performing the multi-link HARQ combination, and configures the timer for the first apparatus by using the first information.

In this disclosure, different HARQ processes may correspond to different duration, to adapt to different services, for example, eMBB and URLLC.

In some other embodiments of this disclosure, the method 800 may further include block 808.

Block 808: The first apparatus sends feedback information.

The feedback information indicates whether the multi-link HARQ combination succeeds, so that the transmitter device of the third data determines whether to perform retransmission. Specifically, when the third data is successfully decoded, the first apparatus sends an ACK; or when the third data fails to be decoded, the first apparatus sends a NACK.

In some embodiments, the first apparatus sends the feedback information to the third apparatus. Correspondingly, the third apparatus receives the feedback information from the first apparatus.

Optionally, an apparatus receiving the feedback information may be an apparatus sending data or may not be the apparatus sending the data.

Optionally, an apparatus receiving the feedback information may be an apparatus sending the first information or may not be the apparatus sending the first information.

It should be noted that if the third data fails to be decoded, the first apparatus may continue to receive fourth data from a third link, and perform HARQ combination on the first data, the second data, and the fourth data based on a HARQ process number of the fourth data and the first information. The third link is a link between the first apparatus and a fourth apparatus. The fourth apparatus and the second apparatus may be the same or may be different, and the fourth apparatus and the third apparatus may be the same or may be different. The first information may be the first information obtained in block 801 (for example, when the first information is configured by using the higher layer signaling), or may be newly obtained first information (for example, when the first information is configured by using the higher layer signaling or the physical layer signaling).

It should be noted that a sequence of block 805, block 806, and block 807 is not limited in this disclosure.

It should be further noted that the third apparatuses related to the first information, the second information, the third information, the fourth information, and the feedback information may be a same apparatus, or may be different apparatuses. In other words, steps related to the first information, the second information, the third information, the fourth information, and the feedback information may correspond to different third apparatuses.

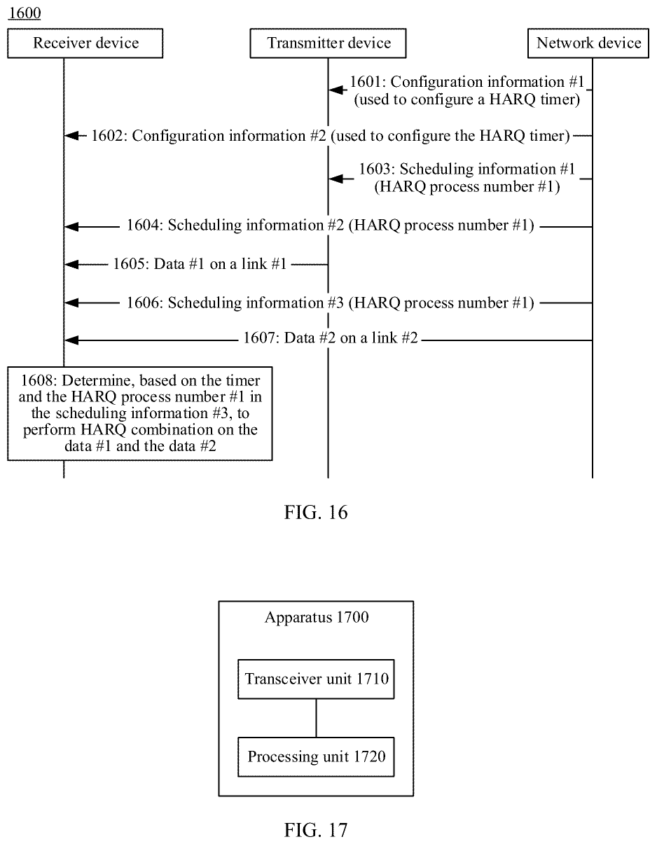

The following describes the technical solutions of this disclosure with reference to specific examples. FIG. 16 is an example of a communication method according to this disclosure. In FIG. 16, a receiver device may correspond to the foregoing first apparatus, a transmitter device may correspond to the foregoing second apparatus, a network device may correspond to the foregoing third apparatus, and a HARQ timer may correspond to the foregoing timer. In FIG. 16, an example in which HARQ combination is performed on data on a link #1 between the receiver device and the transmitter device and data on a link #2 between the receiver device and the network device is used.

Block 1601: The network device sends configuration information #1 to the transmitter device. Correspondingly, the transmitter device receives the configuration information #1 from the network device.

The configuration information #1 is used to configure the HARQ timer for the transmitter device. The HARQ timer herein is used to determine a time period for performing multi-link HARQ combination.

Block 1602: The network device sends configuration information #2 to the receiver device. Correspondingly, the receiver device receives the configuration information #2 from the network device.

The configuration information #2 is used to configure the HARQ timer for the receiver device. The HARQ timer herein is used to determine the time period for performing multi-link HARQ combination.

It should be noted that the configuration information #1 in block 1601 and the configuration information #2 in block 1602 may be combined into one piece of configuration information, or block 1601 and block 1602 may be combined into one. For example, the network device configures the HARQ timer for the receiver device and the transmitter device in a broadcast or multicast manner.

Block 1603: The network device sends scheduling information #1 to the transmitter device. Correspondingly, the transmitter device receives the scheduling information #1 from the network device.

The scheduling information #1 is used to schedule the transmitter device to send data #1 of a HARQ process number #1.

Block 1604: The network device sends scheduling information #2 to the receiver device. Correspondingly, the receiver device receives the scheduling information #2 from the network device.

The scheduling information #2 is used to schedule the receiver device to receive the data #1 of the HARQ process number #1 sent by the transmitter device.

It should be noted that the scheduling information #1 in block 1603 and the scheduling information #2 in block 1604 may be combined into one piece of scheduling information, or block 1603 and block 1604 may be combined into one. For example, the network device sends the scheduling information to the receiver device and the transmitter device in a broadcast or multicast manner.

Block 1605: The receiver device receives the data #1 from the transmitter device.

If the receiver device fails to decode the data #1, the receiver device stores the data #1 in a buffer of the HARQ process number #1.

Block 1606: The network device sends scheduling information #3 to the receiver device. Correspondingly, the receiver device receives the scheduling information #3 from the network device.

The scheduling information #3 is used to schedule the receiver device to receive data #2 of the HARQ process number #1 sent by the network device.

Block 1605: The receiver device receives the data #2 from the network device.

Block 1606: The receiver device determines, based on the HARQ timer and the HARQ process number #1 in the scheduling information #3, to perform HARQ combination on the data #1 and the data #2.

In some embodiments, after receiving the data #2 based on the scheduling information #3, the receiver device determines that the HARQ timer still runs, and determines, based on the HARQ process number #1 in the scheduling information #3, to perform HARQ combination on the data #2 and the data #1 stored in the buffer of the HARQ process number #1.

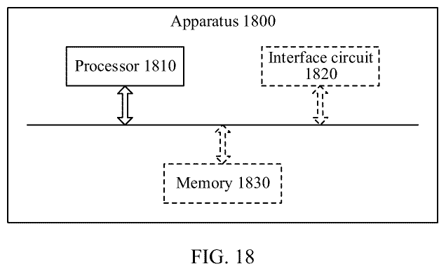

The foregoing describes, in detail with reference to FIG. 8 to FIG. 16, the method provided in this disclosure. The following describes in detail apparatus embodiments of this disclosure with reference to FIG. 17 and FIG. 18. It may be understood that, to implement the functions in the foregoing embodiments, the apparatus in FIG. 17 or FIG. 18 includes a corresponding hardware structure and/or software module for performing each function. A person skilled in the art should be easily aware that, in this disclosure, the units and method steps in the examples described with reference to embodiments disclosed in this disclosure can be implemented by hardware or a combination of hardware and computer software. Whether a function is performed by hardware or hardware driven by computer software depends on particular application scenarios and design constraints of the technical solutions.

FIG. 17 and FIG. 18 each are a diagram of a structure of a possible apparatus according to an embodiment of this disclosure. These apparatuses may be configured to implement the functions of the first apparatus or the third apparatus in the foregoing method embodiments, and therefore may also implement beneficial effects of the foregoing method embodiments.

As shown in FIG. 17, the apparatus 1700 includes a transceiver unit 1710 and a processing unit 1720.

When the apparatus 1700 is configured to implement the function of the first apparatus in the foregoing method embodiments, the transceiver unit 1710 is configured to: obtain first information, where the first information indicates the communication apparatus to perform multi-link HARQ combination; receive first data from a first link, where the first data is initial transmission data or retransmission data for third data, and the first link is a link between the communication apparatus and a second apparatus; and receive second data from a second link, where the second data is retransmission data for the third data, and the second link is a link between the communication apparatus and a third apparatus. The processing unit 1720 is configured to perform HARQ combination on the first data and the second data based on the first information.

In some embodiments, the first information includes at least one of the following information: higher layer configuration information, where the higher layer configuration information indicates that the multi-link HARQ combination is enabled; physical layer information, where the physical layer information indicates that the multi-link HARQ combination is activated; or timer information, where the timer information is used to configure a timer, and the timer is configured to determine a time period for performing the multi-link HARQ combination.

In some embodiments, the physical layer information is carried in unicast physical layer signaling or multicast physical layer signaling.

In some embodiments, the timer information is used to configure the timer at a granularity of at least one of the following: a terminal, a carrier, a BWP, a HARQ process, and a HARQ process group.

In some embodiments, the timer information is used to configure duration of the timer based on at least one of the following information: absolute time, a subcarrier spacing, a quantity of symbols, a quantity of slots, or a quantity of subframes.

In some embodiments, a start moment of the timer is a start moment or an end moment of scheduling information, a start moment or an end moment of initial transmission data for the third data, or a start moment or an end moment of a resource that is indicated in the scheduling information and that is used to send feedback information, the scheduling information is used to schedule the communication apparatus to receive the initial transmission data for the third data, and the feedback information indicates whether the third data is successfully decoded.

In some embodiments, the transceiver unit 1710 is further configured to send the feedback information, where the feedback information indicates whether the third data is successfully decoded.

In some embodiments, the first link and the second link use joint numbering of HARQ process numbers, and a HARQ process number of the first data is the same as a HARQ process number of the second data.

In some embodiments, the transceiver unit 1710 is further configured to obtain third information, where the third information indicates a link using joint numbering, and/or the third information indicates whether joint numbering is enabled.

In some embodiments, whether joint numbering is used and/or a link using joint numbering may be predefined or preconfigured.

In some embodiments, the first link and the second link use independent numbering of HARQ process numbers, and a HARQ process number of the first data is associated with a HARQ process number of the second data.

In some embodiments, the transceiver unit 1710 is further configured to obtain fourth information, where the fourth information indicates HARQ process numbers having an association relationship.

In some embodiments, HARQ process numbers having an association relationship may be predefined or preconfigured.

In some embodiments, the transceiver unit 1710 is further configured to report second information, where the second information indicates a HARQ combination capability of the communication apparatus; and the HARQ combination capability includes at least one of the following: whether the multi-link HARQ combination of a single carrier is supported, whether the multi-link HARQ combination of a plurality of carriers is supported, whether the multi-link HARQ combination of a same subcarrier spacing is supported, whether the multi-link HARQ combination of different subcarrier spacings is supported, whether enabling of the multi-link HARQ combination of semi-static configuration is supported, whether activation of the multi-link HARQ combination of dynamic configuration is supported, whether enabling of the timer-based multi-link HARQ combination is supported, or duration for which data can be buffered.

When the apparatus 1700 is configured to implement the function of the third apparatus in the foregoing method embodiments, the processing unit 1720 is configured to determine first information, where the first information indicates a first apparatus to perform multi-link HARQ combination. The transceiver unit 1710 is configured to send the first information to the first apparatus.

In some embodiments, the first information includes at least one of the following information: higher layer configuration information, where the higher layer configuration information indicates that the multi-link HARQ combination is enabled; physical layer information, where the physical layer information indicates that the multi-link HARQ combination is activated; or timer information, where the timer information is used to configure a timer, and the timer is configured to determine a time period for performing the multi-link HARQ combination.

In some embodiments, the higher layer configuration information is used to enable the multi-link HARQ combination at a granularity of at least one of the following: a terminal, a carrier, a BWP, a HARQ process, and a HARQ process group.

In some embodiments, the physical layer information is carried in unicast physical layer signaling or multicast physical layer signaling.

In some embodiments, the timer information is used to configure the timer at a granularity of at least one of the following: a terminal, a carrier, a BWP, a HARQ process, and a HARQ process group.

In some embodiments, the timer information is used to configure duration of the timer based on at least one of the following information: absolute time, a subcarrier spacing, a quantity of symbols, a quantity of slots, or a quantity of subframes.

In some embodiments, a start moment of the timer is a start moment or an end moment of scheduling information, a start moment or an end moment of initial transmission data for third data, or a start moment or an end moment of a resource that is indicated in the scheduling information and that is used to send feedback information, the scheduling information is used to schedule the first apparatus to receive the initial transmission data for the third data, and the feedback information indicates whether the third data is successfully decoded.

In some embodiments, the transceiver unit 1710 is further configured to receive the feedback information from the first apparatus, where the feedback information indicates whether the third data is successfully decoded.

In some embodiments, the transceiver unit 1710 is further configured to send third information to the first apparatus, where the third information indicates a link using joint numbering, and/or the third information indicates whether joint numbering is enabled.

In some embodiments, the transceiver unit 1710 is further configured to send fourth information to the first apparatus, where the fourth information indicates HARQ process numbers having an association relationship.

In some embodiments, the transceiver unit 1710 is further configured to receive second information reported by the first apparatus, where the second information indicates a HARQ combination capability of the first apparatus; and the HARQ combination capability includes at least one of the following: whether the multi-link HARQ combination of a single carrier is supported, whether the multi-link HARQ combination of a plurality of carriers is supported, whether the multi-link HARQ combination of a same subcarrier spacing is supported, whether the multi-link HARQ combination of different subcarrier spacings is supported, whether enabling of the multi-link HARQ combination of semi-static configuration is supported, whether activation of the multi-link HARQ combination of dynamic configuration is supported, whether enabling of the timer-based multi-link HARQ combination is supported, or duration for which data can be buffered.

In some embodiments, the processing unit 1720 is specifically configured to determine the first information based on the second information.

In some embodiments, the transceiver unit 1710 is further configured to send second data to the first apparatus, where the second data is retransmission data for third data.

In some embodiments, the transceiver unit 1710 is further configured to send scheduling information to the second apparatus, where the scheduling information is used to schedule the second apparatus to send first data to the first apparatus, and the first data is initial transmission data or retransmission data for the third data.

For more detailed descriptions of the transceiver unit 1710 and the processing unit 1720, refer to the related descriptions in the foregoing method embodiments. Details are not described herein again.

As shown in FIG. 18, an apparatus 1800 includes a processor 1810. Optionally, the apparatus 1800 may further include an interface circuit 1820. The processor 1810 and the interface circuit 1820 are coupled to each other. It may be understood that the interface circuit 1820 may be a transceiver or an input/output interface. Optionally, the apparatus 1800 may further include a memory 1830, configured to store instructions executed by the processor 1810, store input data needed by the processor 1810 to run the instructions, or store data generated after the processor 1810 runs the instructions. When the apparatus 1800 is configured to implement the foregoing method, the processor 1810 is configured to implement a function of the processing unit 1720, and the interface circuit 1820 is configured to implement a function of the transceiver unit 1710.

When the apparatus 1800 is a chip used in a first apparatus, the chip implements a function of the first apparatus in the foregoing method embodiments. The chip receives information from another module (for example, a radio frequency module or an antenna) in the first apparatus, where the information is sent by another apparatus to the first apparatus; or the chip sends information to another module (for example, a radio frequency module or an antenna) in the first apparatus, where the information is sent by the first apparatus to another apparatus.

When the apparatus 1800 is a chip used in a third apparatus, the chip implements a function of the third apparatus in the foregoing method embodiments. The chip receives information from another module (for example, a radio frequency module or an antenna) in the third apparatus, where the information is sent by another apparatus to the third apparatus; or the chip sends information to another module (for example, a radio frequency module or an antenna) in the third apparatus, where the information is sent by the third apparatus to another apparatus.

This disclosure further provides a communication apparatus, including a processor. The processor is coupled to a memory. The memory is configured to store a computer program or instructions and/or data. The processor is configured to execute the computer program or the instructions stored in the memory, or read data stored in the memory, to perform the method in the foregoing method embodiments. Optionally, there are one or more processors. Optionally, the communication apparatus includes the memory. Optionally, there are one or more memories. Optionally, the memory and the processor are integrated together, or are disposed separately.

This disclosure further provides a computer-readable storage medium. The computer-readable storage medium stores computer instructions used to implement the method performed by the first apparatus or the third apparatus in the foregoing method embodiments.

This disclosure further provides a computer program product, including instructions. When the instructions are executed by a computer, the method performed by the first apparatus or the third apparatus in the foregoing method embodiments is implemented.

This disclosure further provides a communication system. The communication system includes the first apparatus or the third apparatus in the foregoing embodiments.

For explanations and beneficial effects of related content in any apparatuses provided above, refer to the corresponding method embodiments provided above. Details are not described herein again.

It may be understood that, the processor in embodiments of this disclosure may be a central processing unit (CPU), or may be another general-purpose processor, a digital signal processor (DSP), an disclosure specific integrated circuit (ASIC), a field programmable gate array (FPGA) or another programmable logic device, a transistor logic device, a hardware component, or any combination thereof. The general-purpose processor may be a microprocessor or any regular processor.

The method steps in embodiments of this disclosure may be implemented in a hardware manner, or may be implemented in a manner of executing software instructions by the processor. The software instructions may include a corresponding software module, and the software module may be stored in a random access memory, a flash memory, a read-only memory, a programmable read-only memory, an erasable programmable read-only memory, an electrically erasable programmable read-only memory, a register, a hard disk, a removable hard disk, a compact disc read-only memory (CD-ROM), or any other form of storage medium well-known in the art. For example, a storage medium is coupled to a processor, so that the processor can read information from the storage medium and write information into the storage medium. Certainly, the storage medium may alternatively be a component of the processor. The processor and the storage medium may be disposed in an ASIC. In addition, the ASIC may be located in the first apparatus or the third apparatus. Certainly, the processor and the storage medium may alternatively exist in the first apparatus or the third apparatus as discrete components.

All or some of the foregoing embodiments may be implemented by using software, hardware, firmware, or any combination thereof. When the software is used to implement embodiments, all or a part of embodiments may be implemented in a form of a computer program product. The computer program product includes one or more computer programs or instructions. When the computer programs or instructions are loaded and executed on a computer, all or some of the procedures or functions in embodiments of this disclosure are executed. The computer may be a general purpose computer, a dedicated computer, a computer network, a network device, user equipment, or another programmable apparatus. The computer programs or instructions may be stored in a computer-readable storage medium, or may be transmitted from a computer-readable storage medium to another computer-readable storage medium. For example, the computer programs or instructions may be transmitted from a website, computer, server, or data center to another website, computer, server, or data center in a wired or wireless manner. The computer-readable storage medium may be any usable medium that can be accessed by the computer, or a data storage device, for example, a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive.

In embodiments of this disclosure, unless otherwise stated or there is a logic conflict, terms and/or descriptions between different embodiments are consistent and may be mutually referenced, and technical features in different embodiments may be combined into a new embodiment based on an internal logical relationship thereof.

It may be understood that various numbers in embodiments of this disclosure are merely used for differentiation for ease of description, and are not used to limit the scope of embodiments of this disclosure. Sequence numbers of the foregoing processes do not mean an execution sequence, and the execution sequence of the processes should be determined based on functions and internal logic of the processes.

Unless otherwise stated, meanings of all technical and scientific terms used in embodiments of this disclosure are the same as those usually understood by a person skilled in the technical field of this disclosure. The terms used in this disclosure are merely intended to describe objectives of the specific embodiments, and are not intended to limit the scope of this disclosure. It should be understood that the foregoing descriptions are an example for description, and the foregoing examples are merely intended to help a person skilled in the art understand embodiments of this disclosure, but are not intended to limit embodiments of this disclosure to specific numbers or specific scenarios of the examples. It is clear that a person skilled in the art can make various equivalent modifications or changes based on the examples provided above, and such modifications and changes also fall within the scope of embodiments of this disclosure.

The foregoing descriptions are merely specific embodiments of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A communication method, wherein the communication method is applicable to a first apparatus and the method comprises:
obtaining first information;
receiving first data from a first link, wherein the first data is initial transmission data or retransmission data for third data, and the first link is a link between the first apparatus and a second apparatus;
receiving second data from a second link, wherein the second data is retransmission data for the third data, and the second link is a link between the first apparatus and a third apparatus; and
performing multi-link hybrid automatic repeat request (HARQ) combination on the first data and the second data based on the first information.

2. The communication method according to claim 1, wherein the first information comprises at least one of the following information:
higher layer configuration information, wherein the higher layer configuration information indicates that the multi-link HARQ combination is enabled;
physical layer information, wherein the physical layer information indicates that the multi-link HARQ combination is activated; or
timer information, wherein the timer information is used to configure a timer, and the timer is configured to determine a time period for performing the multi-link HARQ combination.

3. The communication method according to claim 2, wherein
the higher layer configuration information is used to enable the multi-link HARQ combination at a granularity of at least one of the following: a terminal, a carrier, a bandwidth part (BWP), a HARQ process, and a HARQ process group; and/or
the timer information is used to configure the timer at a granularity of at least one of the following: a terminal, a carrier, a BWP, a HARQ process, and a HARQ process group.

4. The communication method according to claim 2, wherein
a start moment of the timer is a start moment or an end moment of scheduling information, a start moment or an end moment of initial transmission data for the third data, or a start moment or an end moment of a resource that is indicated in the scheduling information and that is used to send feedback information, the scheduling information is used to schedule the first apparatus to receive the initial transmission data for the third data, and the feedback information indicates whether the third data is successfully decoded.

5. The communication method according to claim 2, wherein
the physical layer information is carried in unicast physical layer signaling or multicast physical layer signaling; and/or
the timer information is used to configure duration of the timer based on at least one of the following information: absolute time, a subcarrier spacing, a quantity of symbols, a quantity of slots, or a quantity of subframes.

6. The communication method according to claim 1, further comprising:
sending feedback information, wherein the feedback information indicates whether the third data is successfully decoded.

7. The communication method according to claim 1, wherein
the first link and the second link use joint numbering of HARQ process numbers, and a HARQ process number of the first data is the same as a HARQ process number of the second data; or
the first link and the second link use independent numbering of HARQ process numbers, and a HARQ process number of the first data is associated with a HARQ process number of the second data.

8. The communication method according to claim 7, further comprising:
obtaining third information, wherein the third information indicates a link using joint numbering, and/or the third information indicates whether joint numbering is enabled.

9. The communication method according to claim 7, wherein whether joint numbering is used and/or a link using joint numbering is predefined or preconfigured.

10. The communication method according to claim 7, further comprising:
obtaining fourth information, wherein the fourth information indicates HARQ process numbers having an association relationship.

11. The communication method according to claim 7, wherein HARQ process numbers having an association relationship are predefined or preconfigured.

12. The communication method according to claim 1, further comprising:
reporting second information, wherein the second information indicates a HARQ combination capability of the first apparatus.

13. The communication method according to claim 12, wherein the HARQ combination capability comprises at least one of the following:
whether the multi-link HARQ combination of a single carrier is supported,
whether the multi-link HARQ combination of a plurality of carriers is supported,
whether the multi-link HARQ combination of a same subcarrier spacing is supported,
whether the multi-link HARQ combination of different subcarrier spacings is supported,
whether enabling of the multi-link HARQ combination of semi-static configuration is supported,
whether activation of the multi-link HARQ combination of dynamic configuration is supported,
whether enabling of the timer-based multi-link HARQ combination is supported, or duration for which data can be buffered.

14. A communication apparatus, comprising a processor and an interface coupled with the processor, wherein:
the interface is configured to:
obtain first information;
receive first data from a first link, wherein the first data is initial transmission data or retransmission data for third data, and the first link is a link between the communication apparatus and a second apparatus; and
receive second data from a second link, wherein the second data is retransmission data for the third data, and the second link is a link between the communication apparatus and a third apparatus; and
the processor is configured to perform multi-link hybrid automatic repeat request (HARQ) combination on the first data and the second data based on the first information.

15. The communication apparatus according to claim 14, wherein the first information comprises at least one of the following information:
higher layer configuration information, wherein the higher layer configuration information indicates that the multi-link HARQ combination is enabled;
physical layer information, wherein the physical layer information indicates that the multi-link HARQ combination is activated; or
timer information, wherein the timer information is used to configure a timer, and the timer is configured to determine a time period for performing the multi-link HARQ combination.

16. The communication apparatus according to claim 15, wherein
the higher layer configuration information is used to enable the multi-link HARQ combination at a granularity of at least one of the following: a terminal, a carrier, a bandwidth part (BWP), a HARQ process, and a HARQ process group; and/or
the timer information is used to configure the timer at a granularity of at least one of the following: a terminal, a carrier, a BWP, a HARQ process, and a HARQ process group.

17. The communication apparatus according to claim 15, wherein
a start moment of the timer is a start moment or an end moment of scheduling information, a start moment or an end moment of initial transmission data for the third data, or a start moment or an end moment of a resource that is indicated in the scheduling information and that is used to send feedback information, the scheduling information is used to schedule the communication apparatus to receive the initial transmission data for the third data, and the feedback information indicates whether the third data is successfully decoded.

18. The communication apparatus according to claim 15, wherein
the physical layer information is carried in unicast physical layer signaling or multicast physical layer signaling; and/or
the timer information is used to configure duration of the timer based on at least one of the following information: absolute time, a subcarrier spacing, a quantity of symbols, a quantity of slots, or a quantity of subframes.

19. The communication apparatus according to claim 14, wherein the interface is further configured to send the feedback information, wherein the feedback information indicates whether the third data is successfully decoded.

20. The communication apparatus according to claim 14, wherein
the first link and the second link use joint numbering of HARQ process numbers, and a HARQ process number of the first data is the same as a HARQ process number of the second data; or
the first link and the second link use independent numbering of HARQ process numbers, and a HARQ process number of the first data is associated with a HARQ process number of the second data.
